(19) United States
(12) Patent Application Publication
(10) Pub. No.: US 2026/0037894 A1
(43) Pub. Date: Feb. 5, 2026

(54) ARTIFICIAL INTELLIGENCE (AI) BASED SYSTEMS AND METHODS FOR ENHANCING EMPLOYEE ENGAGEMENT AND OPTIMIZING OPERATIONAL WORKFLOWS

(71) Applicant: Katarina Cortney Kemner, Cincinnati, OH (US)

(72) Inventor: Katarina Cortney Kemner, Cincinnati, OH (US)

(21) Appl. No.: 19/288,881

(22) Filed: Aug. 1, 2025

Related U.S. Application Data
(60) Provisional application No. 63/678,863, filed on Aug. 2, 2024.

(51) Int. Cl. G06Q 10/0633; G06F 9/451; G06Q 10/067

(52) U.S. Cl. CPC G06Q 10/06334; G06F 9/453; G06Q 10/0672; G06Q 10/0674

(57) ABSTRACT

Embodiments of the present disclosure provide a computer-implemented method. The computer-implemented method performed by a controller includes generating a plurality of virtual agents with Artificial Intelligence (AI) capabilities based at least on organizational data. Furthermore, the computer-implemented method includes delegating at least a portion of operational workflows to one or more of the plurality of virtual agents. The computer-implemented method further includes generating a plurality of employee digital twins associated with a plurality of respective employees, based at least on employee-specific data. Furthermore, the computer-implemented method includes generating at least one workplace digital twin representing at least one respective workplace environment. The computer-implemented method also includes enabling communication amongst a plurality of disparate groupings generated by selecting a plurality of entities from one or more of a plurality of employee devices, the plurality of virtual agents, the plurality of employee digital twins, or the at least one workplace digital twin.

### TECHNICAL FIELD

The present disclosure relates generally to the application of Artificial Intelligence (AI) based agents and virtual agents in operational workflows and more particularly relates to AI-based systems and methods for the enhancement of employee engagement and optimization of operational workflows.

### BACKGROUND

The success of an organization depends largely upon the efficiency and efficacy of employees working for the organization and the operational workflows deployed. It is not only important for the organization to get the right people with the right skills working on designated tasks, but also how efficiently an organization can automate routine and monotonous tasks to achieve higher productivity. Some of the most well-documented challenges to the success of an organization are workforce shortages, insufficient skill levels of the employees, disinterest of the employees in routine and monotonous tasks, and employee inertia towards learning new skills and adapting to large-scale organizational restructuring. Furthermore, responsiveness to critical but important feedback is also often found to be non-uniform amongst the employees within the same organization.

Another challenging area for the smoother functioning of an organization is inertia toward collaboration amongst cross-functional teams. Because of the highly competitive atmosphere in an organization, different verticals within a singular business unit may not be amenable to comprehensive knowledge sharing, thereby impeding the overall growth of the organization. The reasons for such observations may include personality biases, cultural biases, or a simple lack of adequate face-to-face communication because of the requirement of adherence to strict timelines for disparate project objectives. Statistics indicate that organizations with enhanced employee engagement outperform competing entities quite significantly. Furthermore, it is widely believed that emerging technologies such as generative Artificial Intelligence (AI), leveraging structured and unstructured organizational data, can enhance employee engagement, bridge communication gaps, and streamline operational workflows.

However, current trends indicate that there is still a significant amount of untapped potential in generative AI, Large Language Models (LLMs), automation of tasks using AI-based agents, etc., that can be used to significantly improve employee engagement and operational outcomes.

### SUMMARY

According to an aspect of the present disclosure, there is provided a computer-implemented method. The computer-implemented method performed by a controller includes generating a plurality of virtual agents with Artificial Intelligence (AI) capabilities based at least on organizational data associated with an organization. The organizational data is received from one or more of a Human Resources Information System (HRIS) server, an enterprise server, or a communications server. The plurality of virtual agents has access to the organizational data. The computer-implemented method further includes delegating at least a portion of operational workflows pertaining to the organization to one or more of the plurality of virtual agents. Furthermore, the computer-implemented method includes generating a plurality of employee digital twins associated with a plurality of respective employees of the organization, based at least on employee-specific data. Furthermore, the computer-implemented method includes generating at least one workplace digital twin representing at least one respective workplace environment in the organization. The computer-implemented method also includes enabling communication amongst a plurality of disparate groupings for enabling execution of the operational workflows. The plurality of disparate groupings is generated by selecting a plurality of entities from one or more of a plurality of employee devices associated with the plurality of respective employees, the plurality of virtual agents, the plurality of employee digital twins, or the at least one workplace digital twin.

According to another aspect of the present disclosure, there is provided a server system. The server system includes a controller. The controller includes a processor and a memory unit operably connected to the processor. The memory unit includes machine-readable instructions that, when executed by the processor, cause the controller to generate a plurality of virtual agents with Artificial Intelligence (AI) capabilities based at least on organizational data associated with an organization. The organizational data is received from one or more of a Human Resources Information System (HRIS) server, an enterprise server, or a communications server. Furthermore, the plurality of virtual agents has access to the organizational data. The controller is further caused to delegate at least a portion of operational workflows pertaining to the organization to one or more of the plurality of virtual agents. Furthermore, the controller is caused to generate a plurality of employee digital twins associated with a plurality of respective employees of the organization, based at least on employee-specific data. Furthermore, the controller is caused to generate at least one workplace digital twin representing at least one respective workplace environment in the organization. The controller is also caused to enable communication amongst a plurality of disparate groupings for enabling execution of the operational workflows. The plurality of disparate groupings is generated by selecting a plurality of entities from one or more of a plurality of employee devices associated with the plurality of respective employees, the plurality of virtual agents, the plurality of employee digital twins, or the at least one workplace digital twin.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a logical representation of an infrastructure for enabling several embodiments of the present disclosure, in accordance with an embodiment of the present disclosure;

FIG. 3 illustrates a computer-implemented method for enhancing employee engagement and optimizing operational workflows, in accordance with an embodiment of the present disclosure;

FIG. 4A illustrates an exemplary implementation of a plurality of virtual agents, in accordance with an embodiment of the present disclosure;

FIG. 4B illustrates an implementation of at least one virtual agent as a subject matter expert agent, in accordance with an embodiment of the present disclosure;

FIG. 4C illustrates a logical representation of a plurality of employee digital twins, in accordance with an embodiment of the present disclosure;

FIG. 4D illustrates an implementation of a client application as a dashboard for an employee named Alex on an employee device, in accordance with an embodiment of the present disclosure;

FIG. 4E illustrates an implementation of a virtual agent acting as the communications-assist agent during an exchange of messages between two employees of an organization, in accordance with an embodiment of the present disclosure;

FIG. 4F illustrates a Graphic User Interface (GUI) depicting a plurality of team optimization modes, in accordance with an embodiment of the present disclosure;

FIG. 4G illustrates a GUI for simulating operational outcomes based on a given combination of a list of team members and a plurality of predetermined organizational goals, in accordance with an embodiment of the present disclosure;

FIG. 4H illustrates a GUI depicting predicted outcomes from simulations for two distinct team combinations, for a given scenario, in accordance with an embodiment of the present disclosure;

FIG. 5 illustrates a Kubernetes cluster for the orchestration of the containerized plurality of virtual agents, in accordance with an embodiment of the present disclosure;

FIG. 6A illustrates an implementation of a fourth pod hosted on a first worker node, in accordance with an embodiment of the present disclosure;

FIG. 6B illustrates an implementation of a first pod and a third pod hosted on a second worker node, in accordance with an embodiment of the present disclosure; and

FIG. 6C illustrates an implementation of a second pod hosted on a third worker node, in accordance with an embodiment of the present disclosure.

The drawings referred to in this description are not to be understood as being drawn to scale, except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the context of the specification, the phrase “operational workflow” refers to a structured, repeatable sequence of tasks, activities, or steps that an organization undertakes to achieve a specific operational outcome or deliver a product/service. The operational workflow represents the logical progression of work, outlining how inputs are transformed into outputs through a series of defined actions, often involving multiple individuals, departments, or automated systems. Unlike a generic process, an operational workflow specifically emphasizes the dynamic execution of these steps in the regular functioning of an organization, focusing on efficiency, consistency, and the practical realization of organizational objectives.

In the context of the specification, the phrase “software agent” or the term “agent” refers to a computer program that is designed to operate autonomously for a user or for another software program, and perform predefined tasks to achieve predetermined objectives. A software agent may be able to autonomously acquire data, process data, and generate an output that may be used by the user or the other software program.

In the context of the specification, the phrase “Artificial Intelligence (AI) agent” refers to a software agent that has been trained on large amounts of historical or real-time data, through Machine Learning (ML) algorithms or rule-based systems, to mimic the responses of a human agent. The AI agent is equipped with relatively larger amounts of automation when compared to other software agents and can set goals for itself without the intervention of the human agent or the operator. An AI agent is configured to exhibit characteristics such as autonomy, reactivity to environmental changes, proactivity in pursuing its objectives, and sometimes social ability for communication and collaboration, allowing it to perform complex tasks without constant direct human intervention and adapt its behavior over time.

In the context of the specification, the phrase “multi-agent framework” refers to a framework in which several AI agents, non-AI agents, and human agents can interact with each other to achieve complex objectives. The multi-agent framework generally has predefined protocols for the exchange of data and information amongst all the agents, including AI agents, non-AI agents, and human agents. Some of the examples of existing skeletal development frameworks or multi-agent platforms through which customized multi-agent frameworks can be built through which multi-agent frameworks can be built, include Microsoft AutoGen, JAAD (Java Agent Architecture Development Framework), MASIF (Multi-agent frameworks Interoperability Framework), AgentSpeak, Apache Tuweni, GAMA (Generic Agent Modeling Platform), etc.

In the context of the specification, the phrase “Generative AI (or Gen AI) algorithms” refers to AI-based algorithms that are capable of generating several types of content, including textual content, audiovisual content, and synthetic data. Gen AI algorithms are generally trained on large amounts of data sourced through several online and offline repositories.

In the context of the specification, the phrase “Large Language Model (LLM)” refers to a type of Gen AI model that is designed to perform natural language tasks like generation and comprehension. LLMs are built on machine learning and neural networks and are trained on large datasets to learn patterns and relationships between words and phrases. They can then create new text combinations that mimic natural language based on their training data. LLMs are typically trained on datasets with at least one billion parameters, which is a machine-learning term for the variables in the model that can be used to infer new content. LLMs are based on transformer-based architectures. Transformers are a deep learning architecture specifically designed for handling sequential data like text. They excel at understanding the relationships between words in a sentence and across sentences. This allows LLMs to learn the context and structure of language. Some of the well-known LLMs known in the art include GPT-3 (Generative Pre-trained Transformer 3), Jurassic-1 Jumbo, Megatron-Turing NLG (Natural Language Generation), WuDao 2.0, BLOOM (BigScience Large Open-science Open-access Multilingual Language Model), LaMDA (Language Model for Dialogue Applications), WuDao 2.0 English, Jurassic-1 GPT-J, Gemini (Google AI), etc.

In the context of the specification, the phrase “workflow automation application” refers to a software program used to automate repetitive tasks between web-based applications, such as moving information from one web-based application to another. The automation of repetitive tasks can be achieved through the generation and integration of several customizable automated processes in the workflow automation application. In that regard, each automated process may include a trigger that initiates the process and one or more actions that need to be performed when the trigger condition is satisfied. Some of the applications for workflow automation include Zapier, Make, IFTTT (If This Then That), Pabbly Connect, Microsoft Power Automate, Tray.io, Workato, and Zoho Flow.

In the context of the specification, the phrase “virtual agent” refers to a program capable of interacting with a user through client devices associated with the user. The virtual agent may manifest as a chatbot that may interact with the user through textual messages, voice messages, or may manifest as a visual graphical representation in the form of a human face or any other graphical representation, such as an animal face or an emoji.

In the context of the specification, the phrase “communications mesh” refers to an infrastructure layer that handles communication between several services in an application and between the application and entities external to the application. A communications mesh deployed in an architecture involving containerized microservices is referred to as “service mesh”; however, in the context of the specification, the scope of the communications mesh is envisaged to also include other non-containerized microservices-based alternative architectures. Alternatives to containerized microservices may include traditional monolithic applications, modular monoliths (a structured monolith with well-defined internal modules), serverless functions (Functions-as-a-Service or FaaS), Virtual Machines (VMs), bare-metal servers, and other container orchestration tools like Nomad or Docker Swarm that may or may not emphasize microservice patterns. In the context of the specification, communications meshes are also envisaged to allow the exchange of information between an application (including amongst microservices within the application) and several external data sources such as external databases, client devices, third-party software agents, and multi-agent frameworks. Furthermore, it is envisaged that in the context of the specification, the communications mesh may further enable secure communications between applications and programs through the implementation of features such as Transport Layer Security (TLS) encryption, authentication, and authorization. Furthermore, communications mesh helps ensure data confidentiality and integrity by encrypting traffic. Communications meshes also allow the implementation of authorization policies to control which services can access specific endpoints or perform specific actions.

In the context of the specification, a “scraper agent” is a virtual agent capable of automatically gathering and extracting from network resources such as websites, web-based, and local databases. The data gathered and extracted may be stored in a structured form, such as relational databases, semi-structured form, or unstructured form, such as implementing a data lake.

In the context of the specification, the phrase “server system” refers to a dedicated computing device or a collection of interconnected computing resources, designed to provide specific functionalities, services, or data to other computing devices, known as client devices, over a network. A server system may include robust hardware components, including high-performance processors (CPUs, often with many cores), substantial amounts of random-access memory (RAM), and large-capacity, high-speed storage solutions (such as SSDs or NVMe drives, frequently arranged in RAID configurations for redundancy and performance). These hardware specifications are typically far more extensive and resilient than those found in client devices, engineered to handle concurrent requests from numerous client devices, process complex workloads, and maintain continuous operation. The server system often includes redundant power supplies, cooling systems, and network interfaces to ensure uninterrupted service delivery.

Beyond the physical hardware, a server system runs specialized software. This typically includes a server-grade operating system (like Linux distributions such as Ubuntu Server, Red Hat Enterprise Linux, or Windows Server), which is optimized for network operations, multi-user access, and process management. On top of the operating system, various server applications and services are deployed. These applications range from web servers (for example, Apache, Nginx) that deliver web pages, to database servers (for example, MySQL, PostgreSQL, SQL Server) that manage structured data, to application servers that run business logic, and in the context of the specification, multimedia processing and streaming applications. The entire software stack is configured for efficiency, security, and scalability.

Furthermore, in modern computing, a server system increasingly exists not just as a single physical machine but also as a virtualized entity or a distributed collection of resources. This includes virtual machines (VMs) and containers running on underlying physical servers, allowing for flexible resource allocation, isolation, and rapid deployment. Cloud computing environments exemplify this, where a server system might be an ephemeral instance dynamically provisioned from a vast pool of shared hardware. These distributed server systems communicate over high-speed networks, collectively forming data centers or cloud regions, enabling them to handle massive workloads, offer geographic redundancy, and provide services with high availability and fault tolerance across a global scale.

In the context of the specification, the phrase “Human Resources Information System (HRIS) server” refers to a digital infrastructure that hosts and manages comprehensive employee data and related HR processes of an organization. The HRIS server may act as a secure database for administrative and informational aspects of an employee's tenure within a company, from recruitment to offboarding. This may include storing static details like personal demographics, contact information, job roles, departments, or reporting lines, or dynamic data such as compensation history, benefits enrollment, attendance records, leave requests, performance review scores, disciplinary actions, or training completions. The HRIS server may further provide self-service portals for employees and managers, enabling direct updates and access to information, and may serve as a source for foundational people data that can be integrated with other enterprise systems.

In the context of the specification, the phrase “enterprise server” broadly refers to computing infrastructure that hosts and manages the core operational applications and data for a part of or an entire organization. The enterprise server may support a multitude of systems for the organization's day-to-day functioning and strategic objectives. This may include, but is not limited to, Enterprise Resource Planning (ERP) systems that integrate various functions like finance, supply chain, manufacturing, and inventory; Customer Relationship Management (CRM) systems for managing customer interactions and sales processes; and various other specialized business applications like project management software, accounting systems, data analytics platforms, and industry-specific solutions. Examples of commercially available applications that may be supported by an enterprise server include, but are not limited to, ERP systems such as Workday, SAP S/4HANA, and Oracle Fusion Cloud ERP, CRM platforms such as Salesforce and Microsoft Dynamics 365, and Supply Chain Management (SCM) solutions like those from SAP, Oracle, and Blue Yonder.

In the context of the specification, the phrase “communications server” broadly refers to computing infrastructure that facilitates and manages the flow of several forms of digital communication within and often outside an organization. This includes hosting and orchestrating various communication channels and platforms, such as email systems, instant messaging and chat applications, voice-over-IP (VOIP) telephony, video conferencing solutions, and internal social networking platforms. The communications server may further be configured to ensure reliable, secure, and efficient exchange of information between employees, teams, and external stakeholders. The communications server may further handle message routing, call management, video streams, presence indicators, and the storage of communication logs. Examples of commercially available applications that may be supported by a communications server include, but are not limited to, Microsoft VIVA, Slack, Zoom, Google Workspace (Gmail, Meet, Chat), Cisco Webex, RingCentral, and various Unified Communications as a Service (UCaaS) providers, all of which facilitate various forms of digital communication within and across organizations.

In the context of the specification, the term “historical” in the execution of a command refers to anything pertaining to a time instant(s) that is earlier than a time instant of the initiation of the command.

In the context of the specification, the term “real-time” refers to without intentional delay, given the processing limitations of hardware/software/firmware involved and the time required to accurately measure/receive/process/transmit data as practically possible.

Various embodiments of the present disclosure provide artificial intelligence (AI) based systems and methods for enhancing employee engagement and optimizing operational workflows. The disclosure involves the generation of several virtual agents, employee digital twins, anti-employee digital twins, and one or more workplace digital twins to simulate workplace environments and operational workflows. For the generation of the virtual agents, the employee digital twins, the anti-employee digital twins, and the workplace digital twins, data may be sourced from several databases maintained by several services. These services may include Human Resource Information System (HRIS), Customer Relationship Management (CRM), Product Lifecycle Management (PLM), Enterprise Resource Planning (ERP), or Communication Services such as those providing shared file locations, email, instant messaging, etc. While sources of the data from business systems such as the HRIS, CRM, PLM, ERP, etc., strict adherence to data protection and privacy laws and regulations, such as the General Data Protection Regulation (GDPR) and the California Consumer Privacy Act (CCPA), may be practiced. Such practices may include data minimization, encryption during transmittal and storage, anonymization, data security infrastructure, scheduled audits, etc. Furthermore, adherence to data protection and privacy laws and regulations may be automated using several custom-built and off-the-shelf web-based applications.

The virtual agents, the employee digital twins, the anti-employee digital twins, and the workplace digital twins may be trained on the sourced data using machine learning algorithms such as decision trees, logistic regression, random forest, gradient boosting, K-Nearest Neighbors, Support Vector Machines (SVM), and clustering algorithms. Furthermore, virtual agents, the employee digital twins, and the workplace digital twins may also have access to popularly used multi-agent platforms such as Microsoft Autogen and Large Language Models (LLMs) such as Gemini (Google AI) and GPT-4.5 (Open AI). Furthermore, measures may be taken to address ethical issues related to AI. Such measures may include removing biases, enabling transparency in AI decision-making by implementing Explainable AI (XAI), drafting policies benefiting human employees and agents, and automating compliance with the drafted policies.

Once generated, at least a portion of operational workflows may be delegated to one or more virtual agents, especially the operational workflows that are too repetitive or monotonous, and operational workflows that are too complex to be handled by human personnel. Such virtual agents may leverage web-based automation applications to perform the assigned processes by integration with web-based applications such as spreadsheets, project management applications, inventory management applications, and the like. Furthermore, the virtual agents may be distributed in a hierarchical structure with one virtual agent acting as a central agent controlling all other virtual agents. The virtual agents may also be trained through machine learning algorithms to provide customized messages (such as during communication between two employees), feedback, scheduling, and task assignments to employees of the organization based on employee-specific data sourced from sources like the HRIS server and communications server. Managers may be able to plan operational workflows, gauge employee engagement, and simulate operational outcomes and costs using the employee digital twins, the anti-employee digital twins, and the workplace digital twins.

The virtual agents may also be configured to operate as or leverage scraper agents collecting data and information from several sources, generating expert-data repositories on given subjects. The expert data repositories may then enable one or more of the virtual agents to act as subject matter experts. The interactions of human employees with the virtual agents, the employee digital twins, the anti-employee digital twins, and the workplace digital twins may be enabled in all three modes of communication, including text-based interactions, aural interactions, and visual interactions. Furthermore, the virtual agents, the employee digital twins, and the workplace digital twins may be constantly upgraded using real-world data, actual operational outcomes, real-world translations, and human expertise for their constant evolution and to achieve higher accuracies and efficiencies.

The implementation of the virtual agents, the employee digital twins, the anti-employee digital twins, and the workplace digital twins may offer several advantages. For example, vast amounts of data may be processed to identify patterns and trends that human agents might miss. Forecasting of future trends and outcomes based on historical data is made possible, enabling proactive decision-making. Potential risks and opportunities can be identified, helping businesses mitigate threats and capitalize on new avenues. Repetitive tasks can be automated, freeing up human resources for more strategic work. Operational workflows can be analyzed to identify inefficiencies and suggest improvements. Information can be processed and decisions can be made much faster than humans. Customer data may be analyzed to offer personalized products, services, and recommendations. Operations can be streamlined and costs reduced by optimizing resource allocation. Fraudulent activities can be identified much in advance, preventing financial losses. Inventory management and logistics can be optimized, reducing costs. New product ideas can be generated and product design optimized. Market trends can be analyzed to identify new opportunities. Therefore, the organization can be provided with a competitive advantage by enabling the organization to outpace competitors.

Furthermore, it is envisaged that the virtual agents, the employee digital twins, and the workplace digital twins may be deployed as containerized microservices using web-based applications such as Docker and orchestrated using web-based frameworks such as Kubernetes. Combining containerization and microservices offers several advantages. Containers isolate microservices from the underlying operating system, allowing the microservices to run on any system with a container runtime. This makes applications easier to deploy across different environments, from development machines to production servers. Containers are lightweight and share the kernel of the host system, resulting in faster startup times and lower resource consumption compared to virtual machines. This efficiency allows the packing of more microservices onto a single server, maximizing resource utilization. Since microservices are independent units, the microservices can be scaled up or down individually based on demand. By using container orchestration tools like Kubernetes, the scaling process can be automated for a highly responsive and clastic application. Microservices architecture promotes faster development cycles and easier deployments. Containers further streamline this process by providing a consistent environment for development, testing, and production. This agility allows developers to make changes and deliver new features quickly. If a single microservice crashes, it will not bring down the entire application. Containers isolate microservices from each other, preventing issues in one microservice from impacting others. This improves the overall stability and reliability of the application. Containers provide a familiar development environment for programmers. They can code, test, and deploy microservices using the same container image throughout the development lifecycle.

Kubernetes builds on the benefits of containerized microservices by providing a robust orchestration platform. Kubernetes automates deployments and scaling of containerized microservices. Several instances of a microservice can be defined to run based on resource usage or other metrics, ensuring the application scales seamlessly to meet fluctuating demands. Kubernetes ensures application uptime by automatically replacing failed or unresponsive container instances. This self-healing capability minimizes downtime and keeps the application running smoothly. Kubernetes provides built-in load balancing, distributing traffic efficiently across multiple instances of a microservice. This optimizes performance and prevents bottlenecks. Microservices can discover each other automatically within the Kubernetes cluster. This eliminates the need for manual configuration and simplifies communication between services. Kubernetes efficiently allocates resources between containerized microservices, preventing resource waste and ensuring optimal utilization. Kubernetes itself is portable and can run on various platforms, including public clouds, private clouds, and on-premises infrastructure. This flexibility helps avoid vendor lock-in and allows the movement of the application across environments as needed. Kubernetes integrates well with DevOps practices, enabling Continuous Integration and Continuous Delivery (CI/CD) pipelines. This automation streamlines the development and deployment process for microservices.

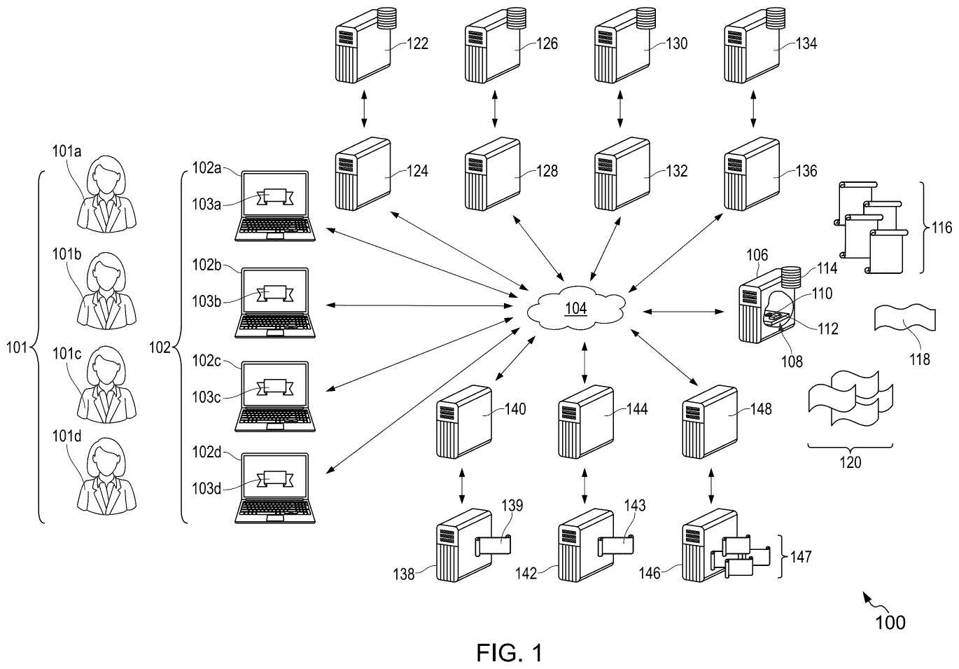

Various embodiments of the present disclosure are described with reference to FIG. 1 to FIGS. 6A-6C.

FIG. 1 illustrates an example representation of an environment 100 related to at least some example embodiments of the present disclosure. The environment 100 includes a plurality of employee devices 102 associated with a plurality of respective employees 101 (such as a first employee device 102 a associated with a first employee 101a, a second employee device 102b associated with a second employee 101b, a third employee device 102c associated with a third employee 101c, and a fourth employee device 102d associated with a fourth employee 101d) running respective client applications 103a, 103b, 103c, and 103d. The plurality of employee devices 102 may be selected from a group consisting of notebook Personal Computers (PCs), desktop PCs, smartphones, tablet PCs, and the like. The plurality of client devices 102 is connected to a communication network 104. In several embodiments, the communication network 104 may be implemented through several combinations of wired and wireless protocols including High Definition Multimedia Interface (HDMI) cables, Video Graphics Array (VGA) cables, Ethernet, Wireless Fidelity (Wi-Fi), Wireless Interoperability for Microwave Access (Wi-Max), Bluetooth, ZigBee, Global System for Mobile Communications (GSM), High-Speed Packet Access (HSPA), High-Speed Downlink Packet Access (HSDPA), Long Term Evolution (LTE), 5G, satellite based networks such as Starlink®, etc. without departing from the scope of the disclosure. In several embodiments, several extra layers of security through Secure Sockets Layer (SSL), Transport Layer Security (TLS), end-to-end encryption, use of device firewalls, and network firewalls may be built into the communication network 104.

The environment 100 further includes several other devices connected to the communication network 104 through their respective Application Program Interface (API) servers. For example, a Human Resources Information System (HRIS) server 122 is connected to the communication network 104 through an HRIS API server 124. The HRIS server 122 is configured to manage and organize employee data and streamline HR processes. The HRIS server 122 may store information on all the employees of the organization in a centralized or distributed database. Such information may include employee core data such as personal information (name, contact details, date of birth, emergency contact details), employment details (job title, department, start date, location, pay rate, employment status), benefits and compensations (details of health insurance, retirement plans, paid time off (PTO) allowances, bonuses, and other compensation details). Furthermore, the HRIS server 122 may store workforce management data such as time and attendance (records of work hours, clock-in/out times, breaks, overtime, and absences), performance management (performance reviews, CliftonStrengths, Core Value Index (CVI), goal setting records, feedback received, disciplinary actions), training and development (records of completed training courses, certifications earned, and skill development activities). The HRIS server 122 may also store compliance and legal data such as tax information (social security number, tax withholding details), immigration documents, and onboarding documents (signed contracts, retainership agreements, Non-Disclosure Agreements, etc.).

Further connected to the communication network 104 is an enterprise server 126 through an enterprise API server 128. The enterprise server 126 is configured to store, manage, and deliver critical data and applications to users across an entire organization. The data may include financial records, customer information, employee files, and business applications. The business applications may include Enterprise Resource Planning (ERP) systems, Customer Relationship Management (CRM) software, and web servers. Further connected to the communication network 104 is a workflow automation application server 130 through a workflow automation API server 132. The workflow automation application server 130 is configured to host a workflow automation application for the automation of several repetitive tasks between web-based applications, such as moving information from one web-based application to another. Also connected to the communication network 104 is a communications server 134 through a communications API server 136. The communications server 134 is configured to manage and store communications amongst several employees of an organization for which the embodiments of the present disclosure are being described. Such communications may include instant messages, official memos, circulars, company policy changes, periodic objectives, press releases, emails, etc.

Further, connected to the communication network 104 is a server system 106 and a storage device 114. The server system 106 is envisaged to run an application enabling several embodiments of the present disclosure. In that regard, the server system 106 may be representative of a single device, a cluster of servers, a cloud-based infrastructure, server farms, and the like, without departing from the scope of the disclosure. The server system 106 is envisaged to include hardware capabilities such as a controller 108. The controller 108 includes a processor 110 and a memory unit 112. The processor 110 may be one or more of a microprocessor, a microcontroller, a general-purpose processor, a System on Chip (SoC), a Graphics Processing Unit (GPU), a Tensor Processing Unit (TPU), a Neural Processing Unit (NPU), a Field Programmable Gate Array (FPGA), a Digital Signal Processor (DSP), an Application Specific Integrated Circuit (ASIC), and the like. The memory unit 112 may be selected from a group consisting of volatile memory units such as, but not limited to, such as Static Random Access Memory (SRAM), Pseudo-Static Random Access Memory (PS-RAM), and Dynamic Random Access Memory (DRAM) of types such as Asynchronous DRAM, Synchronous DRAM, Double Data Rate SDRAM, Rambus DRAM, and Cache DRAM, etc.

The storage device 114 may be a non-volatile memory device of the types including Read-Only Memory (ROM), Erasable Programmable Read-Only Memory (EPROM), Electrically Erasable Programmable Read-Only Memory (EEPROM), magnetic disks, hard disk drives, solid state drives, flash memory, and the like. In several embodiments, the storage device 114 may be implemented as a Storage Area Network (SAN) or Network Attached Storage (NAS). The storage device 114 may store machine-readable instructions for enabling several embodiments of the present disclosure. During run-time, the machine-readable instructions may be loaded into the memory unit 112 for execution by the processor 110 to enable several embodiments of the present disclosure. The storage device 114 may further store several forms of data generated and received during the working of the several embodiments of the present disclosure. The machine-readable instructions stored in the storage device 114 may enable several services and microservices, such as a plurality of virtual agents 116. Furthermore, the machine-readable instructions may enable at least one workplace digital twin 118 to emulate a workplace environment of the organization or a business unit for which several embodiments of the present disclosure may be implemented.

In several embodiments, the at least one workplace digital twin 118 may be generated based on historical and real-time organizational data. There may be several steps involved in the generation of the at least one workplace digital twin 118. Such steps may include the identification of goals intended to be achieved from the at least one workplace digital twin 118. Such goals may include improving efficiency, identifying bottlenecks, or testing process changes. The next step may include data collection. The data may be collected from IT system logs, transaction data, and employee interviews stored on the enterprise server 126, the HRIS server 122, and the communications server 134. The next step may be mining and visualization. Process mining techniques may be used to analyze collected data to identify patterns, variations, and bottlenecks in the processes. Furthermore, the findings may be translated into visual representations such as flowcharts and process maps. Furthermore, a model representing the workplace environment may be built using simulation software, low-code platforms, spreadsheets/databases, etc. The model may further be integrated with IT systems for real-time monitoring and upgradation. Furthermore, the algorithm of the model may be adapted for testing and validation of performance by comparing the model with real processes and outcomes.

In addition, the machine-readable instructions enable a plurality of employee digital twins 120. The plurality of employee digital twins 120 are digital representations of the plurality of respective employees 101 that capture their skills, knowledge, experience, behaviors, and preferences. The plurality of employee digital twins 120, in that regard, may be virtual profiles that reflect individual working styles and contributions of the plurality of respective employees 101. For building the plurality of employee digital twins 120, data may be sourced from the enterprise server 126, the HRIS server 122, and the communications server 134. Other sources of data may include targeted surveys. The data collected may be integrated and analyzed, for example, using machine learning tools, to identify patterns, relationships, and insights into the behavior of the plurality of employees. Based on the results of the analysis, the plurality of employee digital twins 120 may be generated.

Furthermore, the storage device 114 may also enable the generation of several databases during the working of the several embodiments disclosed in the present disclosure enabling several elements of the embodiments to access and store information. Such databases may include relational databases for structured data and NoSQL databases for unstructured data. The storage device 114 may also enable the implementation of data lakes for storing large volumes of raw data, enabling advanced analytics and machine learning capabilities. Furthermore, data stored in the storage device 114 may be encrypted through either symmetric or asymmetric encryption, depending on specific applications. Furthermore, the encryption may be applied to certain files/partitions or entire disks, depending on several factors such as cost and hardware resources available.

Other devices connected to the communication network 104 may include a multi-agent platform server 146 through a multi-agent platform API server 148. The multi-agent platform server 146 is configured to host a multi-agent platform 147. In addition to enabling the tackling of complicated tasks, the multi-agent platform 147 allows the design of new agents with specific skills and knowledge, allowing them to specialize in particular aspects of a problem. This expertise can be combined to achieve a more comprehensive and effective solution. Furthermore, connected to the communication network 104 is a first LLM server 138 through a first LLM API server 140 and a second LLM server 142 through a second LLM API server 144. The first LLM server 138 hosts a first LLM application 139, and the second LLM server hosts a second LLM application 143.

It is to be noted here that the HRIS API server 124, the enterprise API server 128, the workflow automation API server 132, the communications API server 136, the multi-agent platform API server 148, the first LLM API server 140, and the second LLM API server 144 allow seamless integration capabilities with several sources leveraged for the working of the embodiments disclosed. API integration offers several advantages. For example, pertaining to efficiency and productivity, the API integration allows automation of repetitive tasks, saving time and reducing errors, creation of seamless processes across different applications, reduction of manual data entry, and ensuring consistency etc. When it comes to customer experience, API integration delivers tailored experiences based on customer data, improves customer satisfaction through efficient service, and provides consistent interactions across different channels. On business growth and innovation fronts, API integration enables the creation of new products and services, supports business growth by handling increased workloads, differentiates the business through unique integrations, and provides access to valuable insights for informed decision-making.

When it comes to cost reduction, API integration automates processes, eliminates manual labor, and efficiently utilizes existing systems and data. Other benefits of API integration include the ability to adapt to changing business needs and market conditions, fostering teamwork and information sharing, and protecting sensitive data through secure API endpoints. However, the embodiments discussed in the present disclosure are not limited to API-based integration alone. Data integration may also be performed through ETL (Extract, Transform, Load), iPaaS (Integration Platform as a Service), middleware, and other technologies that might be introduced in the foreseeable future, without departing from the scope of the disclosure.

The term API here broadly encompasses various protocols and styles, including the widely adopted RESTful APIs, but also encompasses older technologies like Simple Object Access Protocol (SOAP), and more modern, performance-oriented options like GraphQL and gRPC, or even real-time bidirectional communication via WebSockets. Each of these API variations offers distinct advantages in terms of data efficiency, contract enforcement, or real-time capabilities, allowing for tailored solutions depending on the specific integration needs.

However, a person skilled in the art would appreciate, several other mechanisms can be configured to facilitate inter-server communication, each with unique benefits. One significant alternative involves the use of message queues or brokers, which form the backbone of event-driven architectures. In this model, systems publish events or messages to a central queue (such as Apache Kafka or RabbitMQ), and other systems subscribe to these messages to process them asynchronously. The primary advantage here is extreme decoupling; the sending system does not need to know the recipient's identity or availability, and messages are typically persisted, ensuring reliable delivery even if the consuming system is temporarily offline. This asynchronous nature greatly enhances system resilience, scalability, and responsiveness, as the initiating server is not blocked waiting for a direct response, making it ideal for distributed systems that need to handle varying loads and ensure data integrity across potentially disparate services.

Another method is direct database access in certain legacy integrations or for highly specialized batch processing, where direct data manipulation is unavoidable and tightly controlled. In such scenarios, the direct database access can offer direct, low-latency access to raw data. Furthermore, traditional file transfers may also be employed as an alternative, especially for batch processing and integration with legacy systems. This involves one server generating data into a file (for example, CSV, XML, JSON) and then transferring it to another server via protocols like FTP, SFTP, or by utilizing shared network file systems. The receiving server then ingests and processes this file. The advantages of file transfers lie in their simplicity for handling large volumes of data in non-real-time scenarios, their widespread compatibility with older systems, and their case of use for external partners who might lack API integration capabilities. While slower and less interactive than API-based communication, they are robust for periodic data synchronization, reporting, or large-scale data migrations where immediate response is not critical.

Also, older forms of Remote Procedure Calls (RPC) beyond modern gRPC, such as XML-RPC or JSON-RPC, exist. These allow a program on one server to execute a function or procedure on a remote server as if it were a local call. In that regard, the choice of communication mechanism may be dependent upon factors like latency requirements, data volume, necessary level of coupling, security considerations, and the existing technological landscape of the involved server systems.

The number and arrangement of systems, devices, and/or networks shown in FIG. 1 are presented as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 106 should be understood to be embodied in at least one computing device in communication with the network 104, which may be specifically configured, via executable instructions, to perform steps as described herein, and/or embodied in at least one non-transitory computer-readable medium.

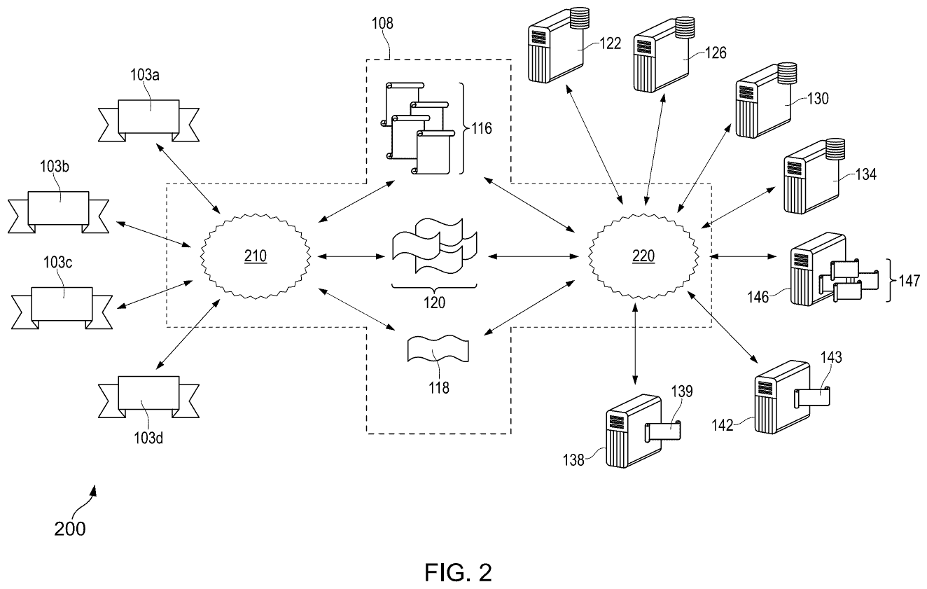

FIG. 2 illustrates a logical representation of an infrastructure 200 for enabling several embodiments of the present disclosure, in accordance with an embodiment of the present disclosure. The controller 108 includes one or more of hardware, software, or firmware resources for generating and/or implementing the plurality of virtual agents 116, the plurality of employee digital twins 120, the at least one workplace digital twin 118, a first communications mesh 210, and a second communications mesh 220. The machine-readable instructions for generating or implementing the plurality of virtual agents 116, the plurality of employee digital twins 120, the at least one workplace digital twin 118, the first communications mesh 210, and the second communications mesh 220 may be stored in the storage device 114 and loaded into the memory unit 112 during runtime for execution by the processor 110. Alternatively, the first communications mesh 210, the second communications mesh 220, the plurality of virtual agents 116, the at least one digital twin 118, and the plurality of employee digital twins 120 can be configured in a variety of ways, including electronic circuitries, digital arithmetic and logic blocks, and memory systems in combination with software, firmware, and embedded technologies.

For instance, virtual agents rely on algorithms that perform computations. The computations, which involve tasks involving natural language processing to decision-making models, may be executed by the digital Arithmetic Logic Units (ALUs) and control units within the processor 110. The instructions for these computations are stored in memory systems, such as high-speed caches, RAM, or persistent storage (such as the storage device 114) as sequences of binary code. Firmware, residing in the storage device 114, provides the low-level instructions to bootstrap the controller 108 and manage basic hardware interactions. The overarching software, including operating systems and application-level code, orchestrates these operations, translating complex agent behaviors into fundamental digital signals that manipulate logic gates and memory states. For instance, a neural network within a virtual agent, when performing an inference, translates into a series of matrix multiplications and activation functions that are carried out by the ALUs of the processor 110, with intermediate results stored and retrieved from memory.

Similarly, digital twins, which are virtual representations of physical assets, systems, or processes, fundamentally depend on this hardware-software synergy. The real-time data streaming from sensors on the physical entity may be converted into digital signals by specialized electronic circuitry and then processed by embedded controllers or larger computing systems. These digital signals are fed into algorithms that update the virtual model, which itself may be represented by data structures residing in the storage device 114. The logic for simulating the physical behavior, predicting performance, or detecting anomalies within the digital twin is executed by the same digital arithmetic and logic blocks. Firmware might handle the communication protocols for sensor data, while software layers may manage the complex modeling, visualization, and analytical tasks that make the digital twin an implementable tool. The responsiveness and fidelity of a digital twin would then directly correlate with the processing power, memory bandwidth, and the efficiency of the underlying digital circuitry.

Furthermore, for a communications mesh, the implementation would involve designing electronic circuitries for high-throughput, low-latency data transmission and reception, including custom radio frequency (RF) front-ends and digital signal processing (DSP) blocks optimized for mesh networking protocols. Digital arithmetic and logic units may be implemented for dynamic routing decisions, network topology management, and security protocols, while memory systems may be configured to store routing tables, encryption keys, and buffered data. Embedded technologies may be implemented in the design of the individual mesh nodes, ensuring they are compact, energy-efficient, and capable of autonomous operation and self-healing. Firmware may be deployed to configure the fundamental behavior of each node, enabling peer-to-peer communication, self-discovery, and adaptive network configurations, thereby creating a resilient and scalable communication fabric built directly into the silicon and integrated at the hardware level with specialized software layers.

The plurality of virtual agents 116, the plurality of employee digital twins 120, and the at least one workplace digital twin 118 may be configured to communicate with the plurality of client applications 103a, 103b, 103c, and 103d through the first communications mesh 210. Furthermore, the plurality of virtual agents 116, the plurality of employee digital twins 120, and the at least one workplace digital twin 118 are in communication with the HRIS server 122, the enterprise server 126, the workflow automation application server 130, the communications server 134, the multi-agent platform server 146, the first LLM server 138 and the second LLM server 142 through the second communications mesh 220. It is also envisaged that communication and exchange of data and information amongst the plurality of virtual agents 116, the plurality of employee digital twins 120, and the at least one workplace digital twin 118 may also be facilitated by one or more of the first communications mesh 210 or the second communications mesh 220.

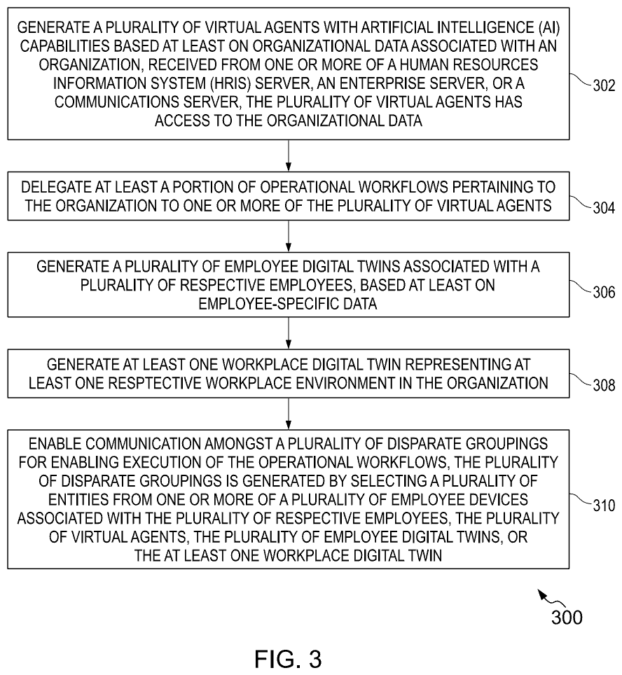

FIG. 3 illustrates a computer-implemented method 300 (hereinafter also referred to as “the method 300”) for enhancing employee engagement and optimizing operational workflows. The method steps of the method 300 may be carried out by the controller 108 through the processor 110 executing the machine-readable instructions loaded into the memory unit 112 during runtime. The method 300 begins at Step 302, when the processor 110 generates the plurality of virtual agents 116 with AI capabilities based at least on organizational data associated with the organization, received from one or more of the HRIS server 122, the enterprise server 126, or the communications server 134. The plurality of virtual agents 116 is envisaged to mimic human-like intelligence, going beyond simple programmed responses. By leveraging technologies like Natural Language Processing and machine learning, these agents can understand context, engage in nuanced conversations, and continuously improve their performance by learning from interactions and data. This enables them to act proactively, anticipating user needs, offering personalized assistance, and efficiently resolving complex issues across various domains, creating evolving, intelligent digital assistants.

In that regard, the plurality of virtual agents 116 is also provided access to the organizational data stored with one or more of the HRIS server 122, the enterprise server 126, or the communications server 134. It is envisaged that the plurality of virtual agents 116 may be provided with machine-learning algorithms such as decision trees, logistic regression, random forest, gradient boosting, K-Nearest Neighbors, Support Vector Machines (SVM), and clustering algorithms. The plurality of virtual agents 116 using the machine learning algorithms would be able to extract valuable insights about the plurality of employees and operational workflows in the organization from the employee-specific data and other data accessed from the HRIS server 122, the enterprise server 126, and the communications server 134. In several alternate embodiments, the plurality of virtual agents 116 may leverage AI agents and non-AI agents provided by the multi-agent platform 147, the first LLM 139, and the second LLM 143 to generate the insights from the data accessed from the HRIS server 122, the enterprise server 126, and the communications server 134.

The plurality of virtual agents 116 may include one or more virtual Subject Matter Experts (SMEs). The virtual SMEs may be trained to possess expert knowledge within a specific domain, such as IT support, regulatory compliance, product knowledge, or internal policies. To generate a virtual SME, data from the enterprise server 126 (for example, knowledge bases, technical documentation, past incident reports, product specifications from an ERP or CRM) provides the core factual information. The HRIS server 122 could supplement this by providing context on who the human experts are, their certifications, or the organizational structure, allowing the virtual SME to potentially refer to human counterparts or understand chains of authority. The communications server 134 may contribute conversational data from past interactions, such as chat logs, email threads, or recorded calls, which would train the NLP models associated with the virtual SME to understand questions and generate human-like, accurate responses, mimicking the communication style of real experts. The goal is for them to answer complex queries, troubleshoot issues, and provide guidance, reducing the burden on human experts.

Furthermore, the plurality of virtual agents 116 may include one or more virtual coaches. The one or more virtual coaches may be designed to provide personalized guidance, feedback, and training to the plurality of employees 101. Generating a virtual coach would rely on data from the HRIS server 122, including employee performance reviews, skill gaps, training histories, career development plans, and even individual goals. The enterprise server 126 might contribute data on specific job roles, project requirements, or organization-wide performance metrics that the coach can reference. The communications server 134 may be deployed for real-time interaction, allowing the virtual coach to engage in conversational practice, provide immediate feedback on communication styles, or facilitate role-playing scenarios. The AI capabilities enable the virtual coach to adapt its coaching style to individual learning patterns, track progress, offer relevant learning resources, and provide empathetic responses, enhancing employee development and well-being.

The plurality of virtual agents 116 may further include one or more virtual project planners. The virtual project planners may be configured to assist in project initiation, resource management, and task assignment. The virtual project planners may draw extensively from project management modules of the enterprise server 126, including past project data, task dependencies, resource availability, budget constraints, and historical performance metrics. The HRIS server 122 would provide information about employee skills, availability, certifications, and previous project involvement, allowing the virtual project planner to intelligently allocate resources based on expertise and workload. Data from the communications server 134, such as team discussions and progress updates, could feed into the ability of the virtual project planner to monitor project health in real-time, identify potential bottlenecks, and suggest reallocations or course corrections. The AI would allow the virtual project planners to optimize schedules, predict risks, and adapt plans as project conditions change, significantly improving project efficiency and success rates.

Furthermore, the plurality of virtual agents 116 may include virtual personal assistants. The virtual personal assistants may act as digital concierges for the plurality of employees 101, managing schedules, setting reminders, facilitating meetings, and retrieving information. The HRIS server 122 may provide personal employee data, preferences, and organizational access rights. The enterprise server 126 may be the source for corporate directories, internal policies, available meeting rooms, and integration with various business applications (like expense reporting systems or CRM for contact management). The communications server 134 may be leveraged by the virtual personal assistants to interact through voice or text, scheduling calls, sending messages, and facilitating quick communication. The AI would enable the virtual personal assistants to learn individual preferences, automate routine tasks, and intelligently prioritize information, freeing up employee time for more complex work.

Beyond the aforementioned examples, other examples include Virtual Sales Assistants (leveraging CRM data from the enterprise server 126, communication logs, and product information to assist sales teams), Virtual IT Helpdesk Agents (using IT service management data and knowledge bases from the enterprise server 126, and communication logs for troubleshooting), and Virtual Onboarding Specialists (drawing employee profile and policy data from the HRIS server 122, training content from the enterprise server 126, and using the communications server 134 to guide new hires). In each case, the virtual agent's intelligence, adaptability, and usefulness are directly proportional to the breadth, depth, and quality of the organizational data it can access, process, and learn from across the HRIS server 122, the enterprise server 126, and the communications server 134.

At Step 304, the processor 110 delegates at least a portion of operational workflows pertaining to the organization to one or more of the plurality of virtual agents 116. For example, repetitive and monotonous tasks may be delegated by the processor 110 to the one or more of the plurality of virtual agents 116. In that regard, the plurality of virtual agents 116 would access the workflow automation application facilitated by the workflow automation application server 130. Such tasks may include downloading attachments from an email and adding them to a shared drive, updating an inventory list in spreadsheet software, and automating publishing on social media. Delegating the repetitive and monotonous tasks to the plurality of virtual agents 116 would boost productivity and enhance employee interest in more creative operational workflows such as lead generation, ideation, brainstorming, and cross-functional communication.

In addition, the plurality of virtual agents 116 may have been trained in data stored with the HRIS server 122, the enterprise server 126, and the communications server 134. As mentioned before, the HRIS server 122 may store workforce management data such as time and attendance (records of work hours, clock-in/out times, breaks, overtime, and absences), performance management (performance reviews, CliftonStrengths, Core Value Index (CVI), goal setting records, feedback received, disciplinary actions), training and development (records of completed training courses, certifications earned, and skill development activities). The HRIS server 122 may also store compliance and legal data such as tax information (social security number, tax withholding details), immigration documents, and onboarding documents (signed contracts, retainership agreements, Non-Disclosure Agreements, etc.).

The enterprise server 126 is configured to store, manage, and deliver critical data and applications to users across an entire organization. The data may include financial records, customer information, employee files, and business applications. The business applications may include Enterprise Resource Planning (ERP) systems, Customer Relationship Management (CRM) software, and web servers. The communications server 134 is configured to manage and store communications amongst several employees of the organization for which the embodiments of the present disclosure are being deployed. Such communications may include instant messages, official memos, circulars, company policy changes, periodic objectives, emails, etc.

Therefore, in addition to the automation of certain repetitive and monotonous tasks, one or more virtual agents of the plurality of virtual agents 116 may also be delegated operational workflows involving mentorship/coaching, social media management, finance, sales, engineering, and other fields, without departing from the scope of the disclosure. In several embodiments, the plurality of virtual agents 116 may work individually to perform assigned tasks. In several alternate embodiments, the plurality of virtual agents 116 may collaborate forming several groups of virtual agents to accomplish complex tasks and simulate organizational procedures such as brainstorming, project reviews, collaborative problem solving, cross-functional team meetings, quality circles, strategy planning sessions, role-playing and simulations, customer journey mapping, retrospective meetings, lead generation, ideation, market research, hiring optimization, organization restructuring, focus groups, and the like.

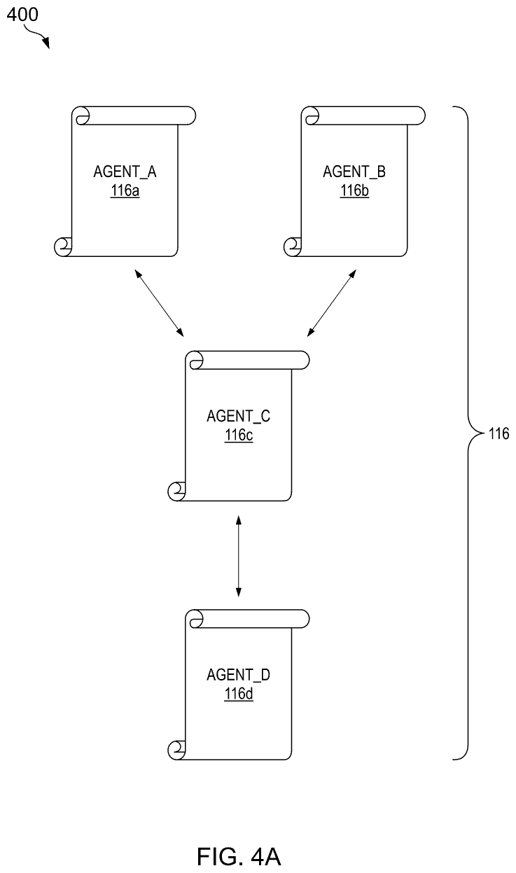

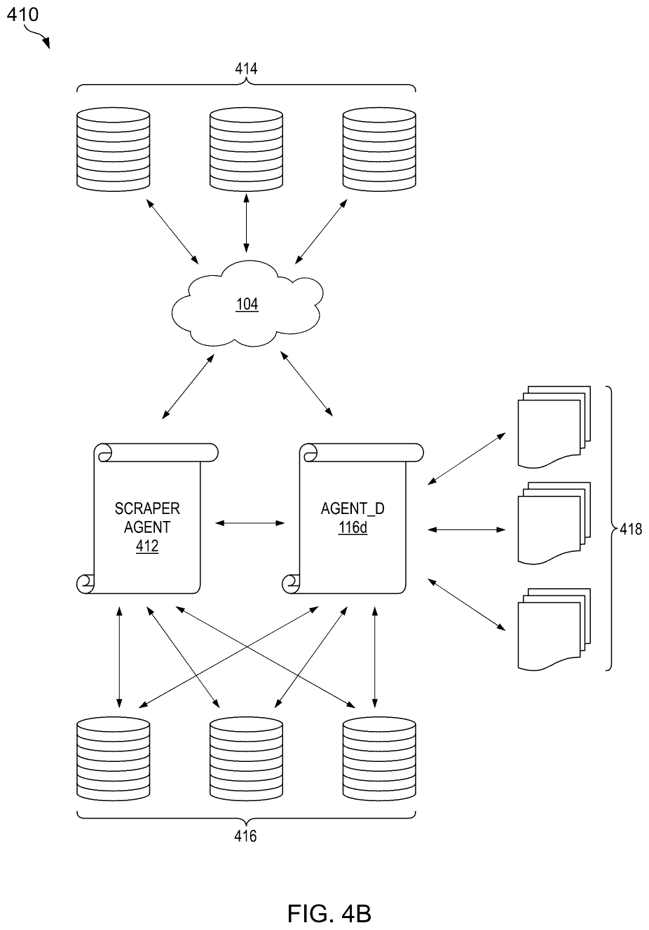

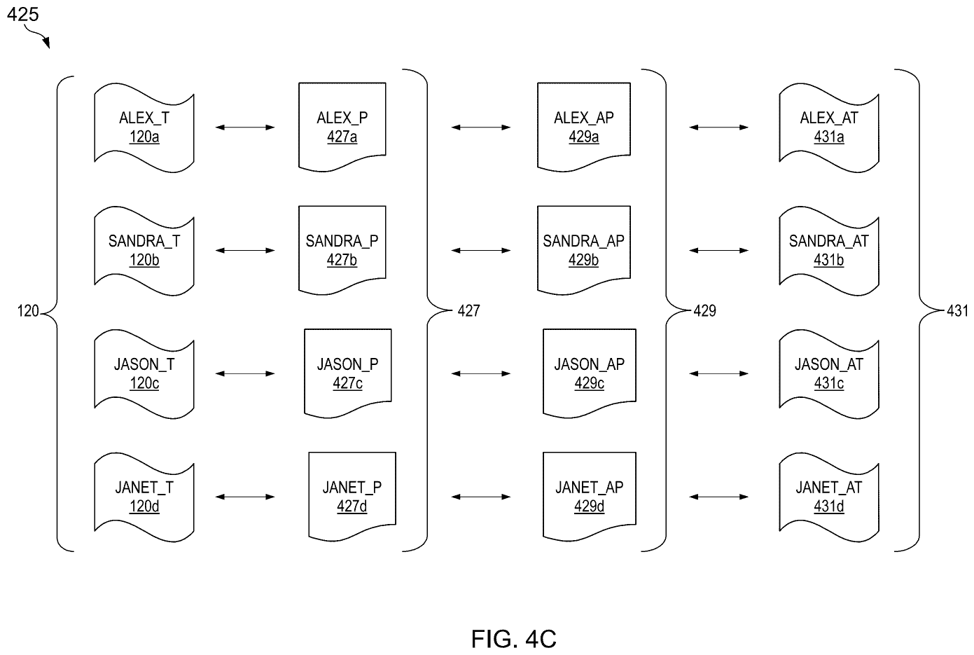

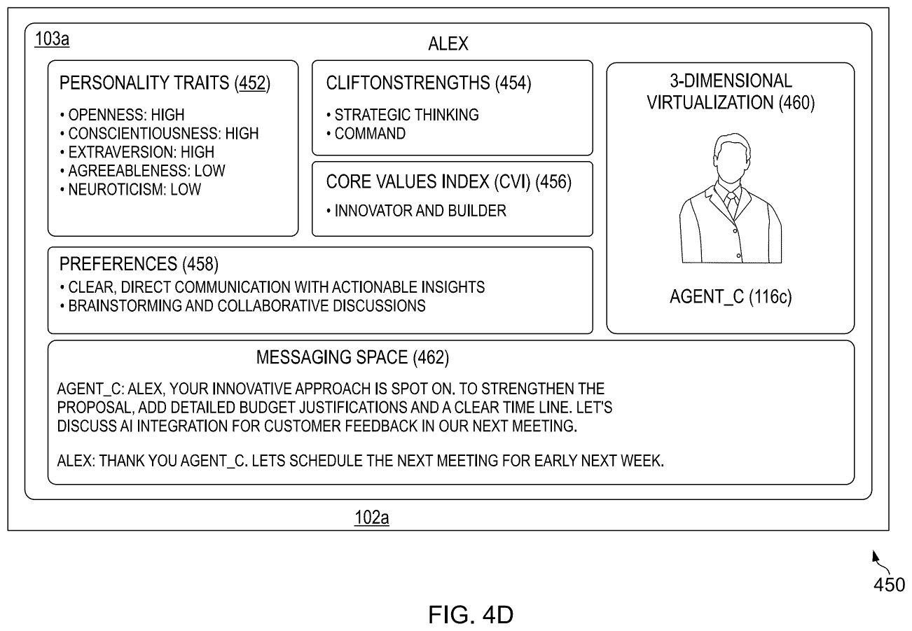

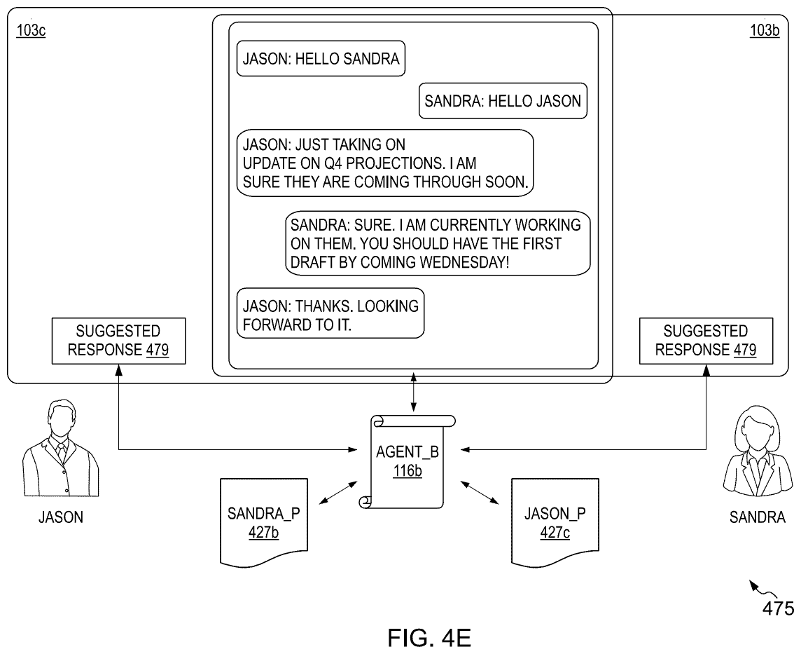

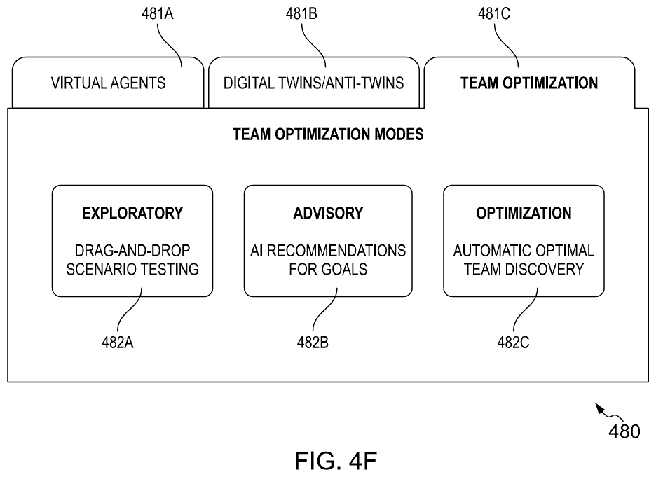

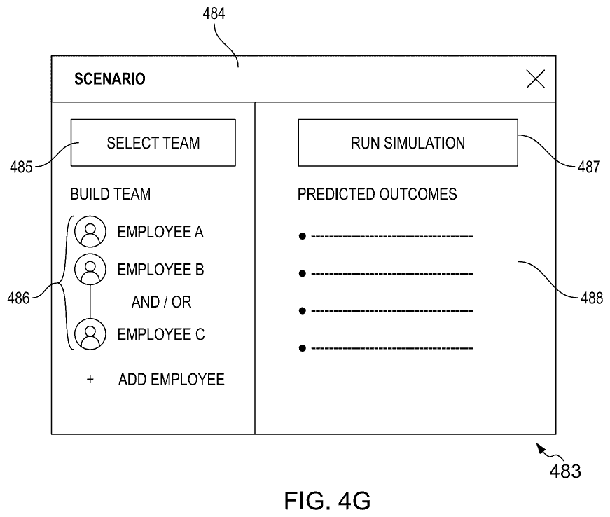

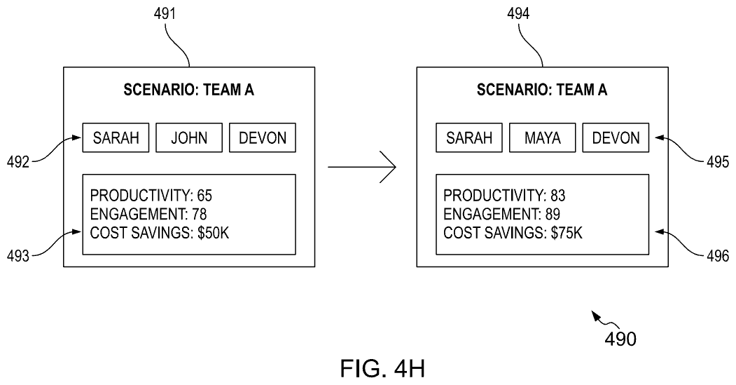

FIG. 4A illustrates an exemplary implementation 400 of the plurality of virtual agents 116, in accordance with an embodiment of the present disclosure. The plurality of virtual agents 116 is envisaged to include at least four virtual agents, AGENT_A 116a, AGENT_B 116b, AGENT_C 116c, and AGENT_D 116d. However, a person skilled in the art will appreciate that, in several embodiments, the plurality of virtual agents 116 may include more agents other than AGENT_A 116a, AGENT_B 116b, AGENT_C 116c, and AGENT_D 116d. Furthermore, AGENT_C 116c is envisaged to be a central agent. Furthermore, AGENT_C may be configured with human-like personality traits in accordance with one or more personality assessment frameworks (for example, Big Five, CliftonStrengths, HEXACO, Myers-Briggs Type Indicator (MBTI), Enneagram, DiSC, etc.). The personality assessment frameworks may also be referred to as qualitative or quantitative psychological/behavioral assessment frameworks. For example, AGENT_C 116c is further equipped with human-like personality traits such as high openness, high conscientiousness, high extraversion, moderate agreeableness, and low neuroticism. Furthermore, CliftonStrengths may be defined for AGENT_C 116c, including activator, focus, and connectedness. CVI of AGENT_C 116c may further indicate innovator and merchant-like qualities. Furthermore, AGENT_C 116c would simulate preferences like clear, direct communication with actionable insights, collaborative discussions, and action-oriented to drive the next steps.

For configuring a virtual agent (such as AGENT_C 116c) with human-like personality traits, the approach may involve translating abstract dimensions of the personality assessment frameworks into a structured, quantifiable set of parameters that an AI model, particularly a Large Language Model (LLM), can interpret and leverage to shape its outputs. For personality assessment frameworks like the Big Five (OCEAN) or HEXACO, which are trait-based and measure continuous scores, the process may involve setting specific values for each dimension. For example, a virtual agent could be given a high score on “Extraversion” and a low score on “Neuroticism.” These scores may then be programmatically injected into the prompt as instructions. The initial system prompt might include a phrase like, “You are a helpful assistant with a high degree of extraversion and a low degree of neuroticism. In all your responses, be outgoing, energetic, and talkative, while avoiding expressions of anxiety or self-pity.” This approach may be useful for LLMs (such as the first LLM 139 and the second LLM 143), which are highly sensitive to context and instruction. The responses of the virtual agent 116c may then be function of both the vast knowledge of the LLMs and the specific personality constraints imposed by the prompt, leading to a consistent and persona-driven communication style. More advanced implementations may use the multi-agent platform 147 where different components of the thought process are influenced by the personality traits, such as a planning module being highly influenced by Conscientiousness for an organized approach, while a social module is influenced by Agreeableness for an empathetic tone.

For type-based frameworks like Myers-Briggs (MBTI) or the Enneagram, the process may focus on guiding the virtual agent 116c towards a specific archetype. An MBTI personality like “INTJ” (Introverted, Intuitive, Thinking, Judging) would be defined by a set of rules and instructions that guide the behavior of the virtual agent 116c towards a logical, strategic, and independent style. The prompt might include instructions to focus on factual data, provide long-term strategic insights, and avoid emotional or overly social language. In the case of the Enneagram, which focuses on core motivations and fears, an inner monologue or thinking process of the virtual agent 116c could be designed to prioritize or be constrained by those motivations. For instance, an Enneagram Type 3 agent might have a primary objective to appear successful and competent, influencing its every response. This is often achieved through a combination of prompt engineering and fine-tuning the underlying AI model on a dataset of interactions that exemplify the desired personality type, allowing the underlying AI model to learn the nuances of the persona more organically.

Advanced methods may involve creating a psychological state for the virtual agent 116c, a dynamic memory that tracks the personality and the emotional state of the virtual agent 116c, allowing the virtual agent 116c to respond differently based on user input and past interactions while remaining consistent with a core persona. This may be handled by a separate module that takes the LLM outputs and filters or rephrases the outputs to align with the defined personality. Alternately, a Likeness Layer or a Personality Layer may be added to the virtual agent 116c that may act as a custom fine-tuned layer on top of the underlying AI model.

The operational workflows assigned to AGENT_C 116c may include central coordination (orchestration of activities of other virtual agents, such as AGENT_A 116a, AGENT_B 116b, and AGENT_D 116d, dynamically assigning tasks based on real-time data, user preferences, and workload), dynamic adaptation (interactions and task assignments based on real-time data and user feedback), and continuous learning (learning from interactions, user feedback, and performance data to improve efficiency and effectiveness over time). However, the provision of human-like personality traits based on the one or more personality assessment frameworks (for example, Big Five, CliftonStrengths, HEXACO, Myers-Briggs Type Indicator (MBTI), Enneagram, DiSC, etc.) may not just be limited to AGENT_C 116c. The same can be applied to other virtual agents of the plurality of virtual agents 116, such as, but not limited to, AGENT_A 116a, AGENT_B 116b, and AGENT_D 116d.

Similarly, AGENT_A 116a may simulate qualities like planning, project management, and analytical thinking. Furthermore, operational workflows assigned to AGENT_A 116a may include task decomposition, scheduling, resource allocation, and dependency management. Furthermore, AGENT_A 116a may integrate with other web-based services such as project management tools (Asana, Trello) and calendars (Google Calendar) through the workflow automation application offered by the workflow automation application server 130, to automate an operational workflow delegated to AGENT_A 116a. Furthermore, AGENT_A 116a may be configured to deploy machine learning algorithms for predictive analytics in project management (for example, estimating task completion times) and implement algorithms like Critical Path Method (CPM) and Gantt charts for task scheduling. As a consequence, in several embodiments, the plurality of virtual agents 116 may be implemented in tiers, with lower tiers offering commonly needed skills-based agents, mid to more premium tiers allowing for adding the skills needed to create custom agents. The plurality of virtual agents 116 may be deployed to automate several other organizational and operational workflow-related tasks, as will be discussed in the following discussion.

FIG. 4B illustrates an implementation of at least one virtual agent (for example, AGENT_D 116d), of the plurality of virtual agents 116, as a subject matter expert agent, in accordance with an embodiment of the present disclosure. In several embodiments, the at least one virtual agent AGENT_D 116d may act as a scraper agent. Alternately, in several embodiments, the at least one virtual agent AGENT_D 116d may deploy or implement a dedicated scraper agent 412 and gather data and information from several web-based or local database repositories to generate one or more of a structured, a semi-structured, or an unstructured expert-data repository related to a given subject matter (for example, costing, marketing, human resource management, etc.). As illustrated in FIG. 4B, one or more of the at least one virtual agent 116d and the dedicated scraper agent 412 may communicate with a plurality of web-based databases 414 through the communication network 104.

The plurality of web-based databases 414 may include databases related to business and market research (for example, prices of products across several retailers, data on competitors, customer reviews, and industry trends, contact information in online directories, monitoring inventory levels, product information, and customer sentiment), finance (stock prices, market trends, and financial news, data on companies, industries, and economic indicators, market conditions and potential risks), academic research (data for research studies and analysis, public opinion on various topics, social media trends and user behavior), and other applications including property listings, pricing, and market data, job listings from different websites, news articles from various sources, data for investigative reporting, and websites and social media, etc.

Furthermore, the one or more of the at least one virtual agent 116d and the dedicated scraper agent 412 may communicate with a plurality of local databases 416. The plurality of local databases 416 may include databases related to the enterprise server 126, the HRIS server 122, the communications server 134, and several other databases maintained by the organization. The one or more of the at least one virtual agent 116d and the dedicated scraper agent 412 may gather data and information from the plurality of web-based databases 414 and the plurality of local databases 416 to generate an expert-data repository 418. The expert-data repository 418 may store the gathered and extracted data in a structured, semi-structured, or unstructured form, for example, by implementing a data lake. The expert-data repository 418 would then be leveraged by the at least one virtual agent 116d to act as a subject matter expert and communicate with other virtual agents or human agents during processes like brainstorming, project reviews, collaborative problem solving, cross-functional team meetings, quality circles, strategy planning sessions, role-playing and simulations, customer journey mapping, retrospective meetings, lead generation, ideation, market research, hiring optimization, organization restructuring, focus groups, “what-if” scenarios, and the like. In that regard, the at least one virtual agent 116d may act as a subject matter expert in one or more fields such as market research, finance, sales, engineering, testing and evaluation, taxation, excise, and the like.

Referring to FIG. 3, at Step 306, the processor 110 generates the plurality of employee digital twins 120 associated with the plurality of respective employees 101 based at least on employee-specific data. As discussed above, the plurality of employee digital twins 120 are digital representations of the plurality of respective employees 101 that capture their skills, knowledge, experience, behaviors, and preferences. The plurality of employee digital twins 120 essentially are virtual profiles that reflect individual working styles and contributions of the plurality of respective employees 101. For building the plurality of employee digital twins 120, the processor 110 may source data from the enterprise server 126, the HRIS server 122, and the communications server 134. Other sources of data may include targeted surveys. It is to be noted here that the plurality of employee digital twins 120 may or may not be static profiles. The plurality of employee digital twins 120 may be evolving, AI-powered representations capable of modeling employee skills, knowledge, work patterns, performance, well-being, and even their likely behavior in different scenarios.

The HRIS server 122 may provide static and semi-static demographic and administrative data about the plurality of employees 101: their job role, department, reporting structure, hire date, salary, benefits, and training records. More dynamically, the HRIS server 122 may offer data on leave requests, attendance patterns, certifications obtained, and formal performance review scores. This HRIS data helps establish the fundamental identity and organizational context for an employee digital twin, mapping the official position of an employee within the company hierarchy and their baseline qualifications. In regard to the enterprise server 126, from an ERP, insights into tasks completed, resources consumed, and outputs generated can be sourced. CRM data can show customer interactions, sales performance, and client feedback. Project management tools provide details on task assignments, project progress, deadlines met (or missed), team collaborations, and individual contributions to projects. This data would allow the employee digital twin to understand the work habits, efficiency, adherence to processes, and contribution to organizational goals associated with a corresponding employee.

The communications server 134 (including email, chat platforms, video conferencing, and internal social networks) may be used for understanding communication patterns, collaboration styles, and sentiments (through sentiment analysis) of the plurality of employees 101. Analysis of message frequency, response times, network centrality (who they communicate with most), and the tone of their communications can reveal their engagement levels, influence, and areas where they might need support in collaboration or communication skills. This unstructured data, processed through Natural Language Processing (NLP) and sentiment analysis, would add qualitative layers to the plurality of employee digital twins 120, reflecting soft skills and interpersonal dynamics.

Targeted surveys are a direct and explicit data source. These can include employee engagement surveys, pulse surveys on well-being, feedback on specific projects, skill self-assessments, or 360-degree performance reviews. While not real-time, surveys provide subjective insights into employee perceptions, satisfaction, mental state, aspirations, and self-reported skills, which are difficult to infer from objective operational data. This qualitative data may further be used for enriching the plurality of employee digital twins 120.

Beyond the core organizational systems, several other data sources can be leveraged or sourced to enhance the plurality of employee digital twins 120. Wearable technology and IoT sensors in the workplace, if implemented ethically and with consent, could provide real-time biometric data (for example, heart rate variability for stress detection), activity levels, or even environmental data from a workspace (for example, temperature, light, noise), offering insights into physical well-being and environmental influences on productivity. Learning Management Systems (LMS) data details course completions, scores, and learning progress, painting a clearer picture of skill development. External professional networking platforms like LinkedIn can provide publicly available information on stated skills, professional connections, endorsements, and external learning activities, complementing internal HRIS data. Furthermore, publicly available industry reports, market trends, and economic indicators can provide external context, helping to model how external factors might influence the role of an employee, future skills requirements, or potential for growth within the organization.

Furthermore, ML models may be deployed to process the operational data from the enterprise server 126 to identify an employee's typical task completion times, predict their future project performance based on historical trends, or even suggest optimal team compositions. From the data received from the communications server 134, ML models, specifically NLP techniques, may be deployed for understanding sentiment, identifying communication styles, and recognizing emerging skills from unstructured text. By continuously feeding new data from the HRIS server 122, the enterprise server 126, communication logs from the communications server 134, and survey results into these ML models, the plurality of employee digital twins 120 can constantly learn and evolve, providing an increasingly accurate and dynamic representation of the plurality of respective employees 101.

In an example embodiment, for the creation of the plurality of employee digital twins 120, the processor 110 may extract required competencies from project requirements concerning a project using NLP. To that end, project requirements maybe stored on the enterprise server 126 that may include specialized applications like Project Portfolio Management (PPM) software, Project Management Information Systems (PMIS), or Application Lifecycle Management (ALM) tools. These enterprise-level applications provide structured databases and interfaces for defining, tracking, prioritizing, and managing requirements throughout the entire project lifecycle. They allow for detailed categorization of requirements (for example, business, functional, non-functional, stakeholder), traceability to other project artifacts like design documents and test cases, version control, and collaboration among various stakeholders.

The processor 110 may perform text preprocessing on project requirement documents, including tokenization (breaking text into words or phrases), lowercasing, removing stop words (common words like “the,” “is”), and stemming or lemmatization (reducing words to their root form) to standardize the text. Following this, Named Entity Recognition (NER) models may be deployed by the processor 110 to create custom dictionaries of relevant competencies or fine-tune pre-trained NER models on domain-specific project requirement datasets to recognize terms like “Python programming,” “cloud architecture,” “project management,” or “data visualization.” Beyond simple keyword extraction, techniques like dependency parsing and relation extraction can analyze the grammatical structure of sentences to understand the relationships between identified entities, for example, “expertise in” or “experience with,” linking a skill to a required proficiency level. Also, text classification or topic modeling may be utilized by the processor 110 to categorize the extracted competencies by type (for example, technical, soft, domain-specific) or group them into broader themes, providing a structured output that directly maps to the competency framework of the organization.

Furthermore, the processor 110 may utilize data from the HRIS server 122 and the communications server 134 to extract features such as skills, past performance, experience, working style, personality traits, and carcer goals associated with the plurality of employees 101. Competing organizational and individual priorities may be balanced through Multi-Objective Optimization. The plurality of employee digital twins 120 may be generated based on the results of the Multi-Objective Optimization. Multi-Objective Optimization significantly enhances the plurality of employee digital twins 120 by defining their optimal state based on both organizational and individual goals. Rather than just mirroring current data, the plurality of employee digital twins 120 would incorporate a desirable path for development and contribution for the plurality of respective employees 101. For example, if MOO identifies the best project allocation balancing deadlines, skills, and carcer goals, a respective employee digital twin would be updated to reflect the same, tracking progress and suggesting adjustments. Similarly, an optimized development plan derived from MOO would structure an employee digital twin to guide the learning journey and predict the future potential of the respective employee.

In such a scenario, the plurality of employee digital twins 120 would capture traits such as skills, competencies, technical abilities, performance history, productivity patterns, personality traits (for example, Big Five, CliftonStrengths, HEXACO, Myers-Briggs Type Indicator (MBTI), Enneagram, DiSC, etc.) extracted from behavioral data, working styles and collaboration preferences, knowledge maps showing expertise and relationships, carcer trajectories and growth potential.

The plurality of employee digital twins 120 can take the form of a comprehensive analytical dashboard and simulation models. In this iteration, an employee digital twin acts as a dynamic data visualization that aggregates all the relevant employee data from the HRIS server 122, the enterprise server 126, the communications server 134, and surveys. The employee digital twin provides a real-timeview of an employee's performance, skill development, well-being metrics, and engagement levels through interactive charts, graphs, and summary statistics. This model could also include simulation capabilities, allowing managers or HR professionals to hypothetically test scenarios, such as the impact of reassigning an employee to a different project or providing specific training, without the employee digital twin itself initiating these actions. The employee digital twin serves as a powerful decision-support tool, enabling human managers to make more informed choices by visualizing potential outcomes and understanding complex interdependencies within an employee's profile.

Another form is a predictive modeling engine focused purely on forecasting. Here, the employee digital twin is primarily a sophisticated predictive model that forecasts various aspects of an employee's future based on historical data. This could include predicting potential flight risk (likelihood of leaving the company), forecasting future performance trends, anticipating skill obsolescence, or identifying early signs of burnout. These predictions are then presented to human decision-makers without the employee digital twin taking any action. For example, the employee digital twin might predict that a particular employee is at high risk of attrition in the next six months based on their tenure, recent workload, and communication patterns, prompting HR to initiate a proactive retention strategy. The emphasis here is on foresight and insight generation, enabling proactive human intervention.

Furthermore, an employee digital twin can manifest as a digital representation for compliance and audit purposes. In this context, the employee digital twin is a meticulously maintained, secure, and auditable record of an employee's professional journey within the organization. This includes detailed logs of training completions, policy acknowledgments, access rights, performance evaluations, and communication compliance. This form is particularly valuable for regulatory adherence, internal audits, and ensuring transparency and fairness in HR processes. It acts as a comprehensive, living dossier, constantly updated with relevant information, providing an irrefutable record of an employee's activities and status within the organizational framework, without necessarily engaging in any active or predictive functions.

Furthermore, the plurality of employee digital twins 120 can be extended to also function as AI agents, creating a functional symbiotic relationship. If a digital twin is merely a data-driven model, an AI agent is a model that can act or advise. By imbuing the plurality of employee digital twins 120 with AI agent capabilities, the plurality of employee digital twins 120 moves beyond being passive data representations to active, intelligent entities. For example, an employee digital twin that models an employee's skill gaps (derived from HRIS and enterprise data) could, as an AI agent, then proactively suggest personalized training modules, recommend specific mentors, or even alert a manager to potential burnout risks based on communication patterns and workload analysis. Similarly, an employee digital twin that understands an employee's expertise and availability could, as an AI agent, automatically recommend them for relevant projects or suggest optimal resource allocation within a project planning system. The AI agent aspect allows the insights derived from the data to be translated into actionable recommendations, automated interventions, or intelligent assistance.

Furthermore, combining different aspects of an employee's virtual representation may provide a more comprehensive context, more accurate predictions, and a broader range of insights than any single form could offer in isolation. For instance, one combination may be a Performance-Wellbeing-Skills digital twin. This would merge the operational data reflecting an employee's task completion rates, project contributions, and sales figures (from the enterprise server 126) with data related to their mental and physical well-being (derived from surveys, communication patterns indicating stress, or even consent-based wearable data). Simultaneously, it would incorporate and dynamically update their skill profile (from HRIS, LMS records, project experience, and peer endorsements). This integrated twin could not only highlight an employee's strong performance areas but also proactively signal if high performance is coming at the cost of declining well-being, or if a particular project might lead to skill gaps if not addressed with targeted training. The combined insights enable personalized interventions that balance productivity with employee health and career development.

Another useful combination could be a Retention-Engagement-Development digital twin. This would involve integrating predictive models for attrition risk (based on HRIS data like tenure, salary history, and communication patterns) with real-time measures of employee engagement (derived from communication sentiment, participation in internal forums, and pulse surveys). This would be further enriched with data that informs personalized development pathways (from LMS records, performance reviews, and skill assessments). Such a hybrid twin could identify employees at high risk of leaving, understand the underlying reasons (for example, low engagement, lack of development opportunities), and then, potentially as an integrated AI agent, suggest specific, targeted interventions like a new mentorship program, a challenging project assignment, or a personalized learning curriculum to increase their engagement and retention, effectively preventing costly turnover.

Furthermore, a Collaboration-Influence-Expertise digital twin may offer insights into an employee's role within team dynamics and knowledge sharing. This form would combine communication network analysis (from the communications server 134) to map who an employee interacts with, how frequently, and on what topics, with data reflecting their formal and informal expertise (from HRIS, project roles, and potentially knowledge base contributions from the enterprise server 126). Such a twin could identify key influencers or bottlenecks in information flow, reveal unrecognized subject matter experts, or highlight individuals whose expertise is underutilized. By understanding both the formal and informal networks and knowledge repositories, this combined twin can inform better team formation, optimize knowledge transfer strategies, and enhance overall organizational learning and innovation.

The generation of the plurality of employee digital twins 120 has several benefits. For example, the plurality of employee digital twins 120 may be used for understanding skill gaps to create customized training programs. The plurality of employee digital twins 120 could be used to create virtual simulations of work situations. This allows employees to practice and refine their skills in a safe, controlled environment before encountering real-world challenges. By analyzing historical data and employee behavior patterns, the plurality of employee digital twins 120 could potentially predict future performance. This allows managers to identify high-potential employees and those needing additional support. The plurality of employee digital twins 120 could provide employees with immediate feedback on their work performance, allowing for course correction and continuous improvement. The feedback coming from a digital twin may be more amenable to an employee as it may be provided discretely without any other individual noticing especially if the feedback is critical or negative. The plurality of employee digital twins 120 can empower employees by providing them with insights into their strengths and weaknesses, guiding their career development goals. Furthermore, the plurality of employee digital twins 120 can identify personality matches and prevent conflicts before they happen. Also, the plurality of employee digital twins 120 can reveal hidden skills and knowledge dependencies.

It is to be noted that while accessing the employee-specific data, compliance with data privacy and protection legislation like the General Data Protection Regulation (GDPR) and California Consumer Privacy Act (CCPA) should be ensured. Systems and practices may be coded in the machine-readable instructions stored in the storage device 114 to ensure compliance at all stages of the working of the embodiments disclosed in the present disclosure. Identification and documentation may be performed for a legal basis for processing personal data, such as consent, contract performance, legal obligation, vital interests, public task, or legitimate interests. Data minimization may further be implemented to ensure only data that is necessary for the specified purpose is collected and excessive data collection is avoided. Furthermore, processor 110 may create prompts to obtain explicit, informed consent from users where required. Moreover, documentation with clear and accessible information about how their data will be used may be provided to the users. Furthermore, the processor 110 executing machine-readable instructions may implement mechanisms or individuals to access, rectify, delete, or restrict the processing of their data. Furthermore, users may be provided with the ability to withdraw consent and object to data processing.

Other measures that may be built into the machine-readable instructions include data anonymization, algorithmic transparency and fairness, regular and automated audits and assessments, documentation and record keeping, and monitoring by one or more virtual agents deployed as legal experts. Furthermore, for the automation of compliance with GDPR and CCPA, several tools may be deployed at various stages. Automated data discovery tools can scan and map out where personal data is stored across all systems. Examples include BigID, OneTrust, and Informatica. A data inventory may be maintained of data assets that include details about data sources, types of data collected, purposes of processing, and data flows. Consent Management Platforms (CMPs) may be implemented to automate the collection and management of user consent. Tools like TrustArc, Cookiebot, and Quantcast can help manage consent for cookies and other data processing activities. Furthermore, dynamic consent forms may be implemented that dynamically update based on user interactions, ensuring that users are always providing informed consent for specific use cases.

Furthermore, the processor 110 executing the machine-readable instructions may further implement self-service portals where users can submit and manage their data access, deletion, and portability requests. The self-service portals may be configured to automate identity verification and track request statuses. Tools may be used to automate the workflows for handling data subject requests. Solutions like OneTrust, TrustArc, and DataGrail can help automate these processes. The processor 110 may further implement data-minimization tools that automatically enforce data minimization principles, ensuring only necessary data is collected and retained. Furthermore, automated data retention policies may be utilized that automatically apply and enforce data retention policies, deleting data that is no longer needed after a certain period. Furthermore, the processor 110 may deploy security solutions that continuously monitor for vulnerabilities, unauthorized access, and data breaches. Tools like Splunk, SIEM systems, and automated patch management tools may be integrated into the business logic. Furthermore, the processor 110 may integrate incident response platforms that automate the detection, reporting, and management of data breaches. These systems can help ensure timely notification to authorities and affected individuals.

For visualization purposes, the processor 110 executing the machine-readable instructions may further generate dashboards that provide real-time insights into compliance status across the organization. These dashboards may be configured to include metrics on data subject requests, consents, and security incidents. Furthermore, the processor 110 may employ tools that automatically audit the systems for compliance with GDPR and CCPA. These tools can generate reports and highlight areas that need attention. To mitigate third-party risks, the processor 110 may deploy tools that automate the assessment of third-party vendors for compliance with GDPR and CCPA requirements. Platforms like OneTrust Vendorpedia can help manage third-party risk. Furthermore, the processor 110 may implement systems that automate the creation, management, and monitoring of data processing agreements and contracts with vendors. Some of the examples of contract management tools include DocuSign CLM, SAP Ariba, Icertis, Concord, PandaDoc, Agiloft, ContractWorks, and the like.

For the specific reasons concerning the use of AI in the embodiments discussed in this specification, the processor 110 may further deploy tools that provide transparency and explainability for AI models. Solutions like IBM Watson OpenScale and Fiddler can help ensure that AI decisions are understandable and fair. Furthermore, for bias mitigation, automated tools to detect and mitigate biases in AI models may also be implemented. These tools can continuously monitor and adjust models to ensure compliance with fairness requirements. For the employees and other human agents and personnel related to the organization, e-learning platforms may be used to provide ongoing training and awareness programs for employees. These platforms can track completion rates and ensure that all staff are up-to-date on compliance requirements. Furthermore, the processor 110 executing the machine-readable instructions may ensure that the compliance tools and processes are regularly updated to reflect changes in the regulatory landscape. Automated compliance tools may be further configured to receive updates to stay current with new laws and guidelines. Furthermore, the processor 110 may implement feedback mechanisms to continuously improve compliance strategies based on user and stakeholder feedback.

Referring to FIG. 3, at Step 308, the processor 110 generates at least one workplace digital twin 118 representing at least one respective workplace environment in the organization. As discussed above, there may be several steps involved in the generation of the at least one workplace digital twin 118. For example, when executing the machine-readable instructions, the processor 110 may access one or more goals intended to be achieved through the at least one workplace digital twin 118. Such goals may include improving efficiency, identifying bottlenecks, or testing process changes. The next step may include the processor 110 performing data collection from a plurality of data sources. The data may be collected from IT system logs, transaction data, and employee interviews stored on the enterprise server 126, the HRIS server 122, and the communications server 134.

The processor 110 may then perform mining and visualization. Process mining techniques may be used to analyze collected data to identify patterns, variations, and bottlenecks in the processes. Furthermore, the findings may be translated into visual representations such as flowcharts and process maps. Furthermore, the processor 110 may build the at least one workplace digital twin 118 representing the at least one workplace environment using the collected data and simulation software, low-code platforms, spreadsheets/databases, etc. The processor 110 may further integrate the model at least one workplace digital twin 118 with the Information Technology (IT) infrastructure associated with the organization, for real-time monitoring and upgradation. Furthermore, the algorithm of at least one workplace digital twin 118 may be adapted for testing and validation of performance by comparing the at least one workplace digital twin 118 with real processes and outcomes.

In that regard, the at least one workplace digital twin 118 may be a virtual replica of a physical office environment, a building, or even an entire campus, designed to mirror its actual state, dynamics, and performance in real-time. Unlike a static 3D model, the at least one workplace digital twin 118 may continuously update with data from various sensors and systems, allowing the at least one workplace digital twin 118 to provide comprehensive insights and facilitate proactive management. This virtual representation can take several distinct forms, each serving different analytical and operational purposes for optimizing the physical workspace.

One common form is the spatial and occupancy digital twin. In this form, the at least one workplace digital twin 118 would focus on the physical layout and how it is being used. The at least one workplace digital twin 118 would combine detailed architectural drawings (like BIM models) with real-time data from IoT sensors, such as occupancy sensors, heat maps, and access control systems. This allows the at least one workplace digital twin 118 to visualize actual space utilization, identify underutilized or overcrowded areas, track foot traffic patterns, and analyze the flow of people throughout the building. Facility managers can use this form to optimize floor layouts, assign workspaces dynamically, manage hot-desking, and even predict peak usage times, ensuring efficient space utilization and enhancing employee comfort by preventing overcrowding or underutilization.

Another form is the environmental and comfort digital twin. In this form, the at least one workplace digital twin 118 would concentrate on the environmental conditions within the workplace and their impact on occupant well-being. The at least one workplace digital twin 118 would integrate data from smart building systems, including HVAC (heating, ventilation, and air conditioning), lighting controls, air quality sensors (CO2, VOCs, humidity, temperature), and even noise monitors. The at least one workplace digital twin 118 can then visualize these conditions in real-time, identify areas with suboptimal air quality, inconsistent temperatures, or excessive noise, and even predict how changes in these factors might affect employee comfort and productivity. This allows for proactive adjustments to building systems to create a more comfortable, healthy, and energy-efficient work environment, directly contributing to employee satisfaction and reducing operational costs.

Furthermore, the at least one workplace digital twin 118 can manifest as a predictive maintenance and asset management twin. This form focuses on the operational health and lifecycle of physical assets within the workplace, such as HVAC units, elevators, lighting fixtures, and IT equipment. The at least one workplace digital twin 118 would ingest data from asset monitoring systems, historical maintenance records, and sensor readings (for example, vibration, temperature, energy consumption) to create a virtual model of each asset's performance. The at least one workplace digital twin 118 would then be able to predict potential equipment failures before they occur, allowing facility teams to schedule proactive maintenance, minimize downtime, and extend the lifespan of costly assets. The at least one workplace digital twin 118 can also optimize energy consumption by identifying inefficiencies in equipment operation, leading to significant cost savings and improved sustainability.

Also, the at least one workplace digital twin 118 may serve as a security and emergency response simulation twin. This form integrates data from security cameras, access logs, fire alarm systems, and emergency exits, mapping them onto the physical layout. The at least one workplace digital twin 118 would then be able to simulate various scenarios, such as emergency evacuations, security breaches, or active shooter situations, allowing security personnel and first responders to plan and train effectively. By visualizing potential choke points, optimal evacuation routes, and the real-time location of individuals during a crisis, this form would provide critical information for improved safety protocols, faster response times, and better crisis management within the workplace.

Furthermore, different combinations of the various forms of the at least one workplace digital twin 118 may also be implemented. Instead of being isolated entities, these forms (spatial/occupancy, environmental/comfort, predictive maintenance/asset management, and security/emergency response) are highly complementary and, when integrated, create a far more comprehensive and intelligent virtual representation of the workplace.

For example, the organization might deploy a combined Spatial-Environmental-Predictive Maintenance digital twin. This would allow facility managers to not only see which areas are over-occupied (spatial data) but also correlate that with rising CO2 levels or temperatures (environmental data) and simultaneously check the maintenance status of the HVAC units serving those areas (predictive maintenance data). If a particular meeting room is constantly overcrowded and its ventilation system is due for service, the combined twin could highlight this as a potential health or comfort issue requiring immediate attention, optimizing both space usage and environmental quality.

Similarly, a Security-Occupancy-Communications digital twin could be implemented, especially in a dynamic office environment. This combination would track real-time occupancy and movement patterns (spatial/occupancy data), integrate with access control systems for security monitoring, and potentially even leverage communication data (from a communications server) to understand who is expected in certain areas or during specific events. In an emergency, this integrated twin could rapidly identify the last known locations of individuals, guide first responders to areas with high concentrations of people, and even optimize evacuation routes in real-time based on real-world obstacles or crowd movement, significantly enhancing emergency response capabilities.

The at least one workplace digital twin 118 offers several advantages. The at least one workplace digital twin 118 can analyze real-time data on how a business operates. This allows the identification of bottlenecks, optimization of processes, and enables data-driven decisions to improve efficiency and productivity. The ability to simulate different scenarios within the at least one workplace digital twin 118 is a powerful tool for innovation. New ideas, products, or processes can be tested in a safe virtual environment. This helps to identify potential risks and challenges before real-world implementation, leading to more successful innovation with minimized risks The at least one workplace digital twin 118 can be used to understand how customers interact with the products and services. This data can then be used to improve the customer experience and develop new offerings that better meet their needs.

It is to be noted here that the processor 110 may further leverage machine learning algorithms like decision trees, logistic regression, random forest, gradient boosting, K-Nearest Neighbors, Support Vector Machines (SVM), and clustering algorithms on the data received from the HRIS server 122, the enterprise server 126, and communications server 134 to generate the plurality of employee digital twins 120 and the at least one workplace digital twin 118. The processor 110 may further leverage one or more of the multi-agent platform 147, the first LLM 139, and the second LLM 143 for the generation of the plurality of employee digital twins 120 and the at least one workplace digital twin 118.

Furthermore, it is envisaged, that in several embodiments, the plurality of virtual agents 116, the plurality of employee digital twins 120, and the at least one workplace digital twin 118 may be designed to evolve as they interact with an environment including each other, other business systems and data sources such as CRM, ERP, and manufacturing software, and human agents such as employees at different hierarchical levels. In that regard, the plurality of virtual agents 116, the plurality of employee digital twins 120, and the at least one workplace digital twin 118 may deploy some rapidly evolving techniques. Such techniques may include reinforcement learning that allows algorithms to learn through trial and error. The plurality of virtual agents 116, the plurality of employee digital twins 120, and the at least one workplace digital twin 118 may interact with the environment, receive rewards or penalties for their actions, and adjust their behavior accordingly. Another technique includes evolutionary algorithms, which are inspired by natural selection. In the scenario of evolutionary algorithms, the plurality of virtual agents 116, the plurality of employee digital twins 120, and the at least one workplace digital twin 118 may create a population of solutions, evaluate their fitness, and select the best ones to breed, producing new generations of improved solutions.

Another technique known as transfer learning would enable the plurality of virtual agents 116, the plurality of employee digital twins 120, and the at least one workplace digital twin 118 to leverage knowledge gained from one task to improve performance on another, related task. This can accelerate learning in new environments. Other techniques may involve meta-learning, imitation learning, hierarchical reinforcement learning, lifelong learning, etc., and other similar techniques that may be developed in the foreseeable future for continuous and autonomous evolution of the plurality of virtual agents 116, the plurality of employee digital twins 120, and the at least one workplace digital twin 118 are envisaged to be within the scope of the disclosure.

Furthermore, since there would be several instances when the plurality of virtual agents 116, the plurality of employee digital twins 120, and the at least one workplace digital twin 118 would be interacting with the human agents and documents and files created by or in assistance with the human agents, the plurality of virtual agents 116, the plurality of employee digital twins 120, and the at least one workplace digital twin 118 may be provided with several additional capabilities such as state-of-the-art Natural Language Processing (NLP) techniques and sentiment analysis techniques. The NLP and sentiment analysis may be performed using labeled training data, deployment of state-of-the-art algorithms such as Naive Bayes, Support Vector Machines (SVM), Random Forest, and Deep Learning models (RNNs, CNNs, Transformers such as BERT (Bidirectional Encoder Representations from Transformers) and GPT (Generative Pre-trained Transformer)), and feature engineering (extracting relevant features from text (for example, word counts, n-grams, sentiment lexicons)).

Pre-defined dictionaries (for example, AFINN, VADER, SentiWordNet) may be used to assign sentiment scores to words and aggregate them to determine the overall sentiment. Furthermore, advanced models such as LSTM, GRU, or transformers (for example, BERT, ROBERTa) may be used for more accurate sentiment analysis. In addition to the integration of Transformer-based models, LLMs, and other machine learning algorithms, the plurality of virtual agents 116, the plurality of employee digital twins 120, and the at least one workplace digital twin 118 may be provided with multi-lingual capabilities.

FIG. 4C illustrates a logical representation 425 of the plurality of employee digital twins 120, in accordance with an embodiment of the present disclosure. The plurality of employee digital twins 120 (for example, ALEX_T 120a, SANDRA_T 120b, JASON_T 120c, and JANET_T 120d) has therewith associated a plurality of respective employee personality profiles 427 (for example, ALEX_P 427a, SANDRA_P 427b, JASON_P 427c, and JANET_P 427d). The plurality of employee digital twins 120 has been named as per the associated employees by appending “T” while the plurality of respective employee personality profiles 427 have been named by appending “_P” to the names of associated employees. The plurality of employee personality profiles 427 may be generated by based on the one or more personality assessment frameworks and the employee-specific data from the HRIS server 122, the enterprise server 126, and the communications server 134.

In that regard, for generating the plurality of employee personality profiles 427, the processor 110, while executing machine-readable instructions, may analyze patterns in employee behavior, such as communication style, task orientation, and problem-solving approaches. Furthermore, the processor 110 may identify correlations between performance and personality traits, such as conscientiousness and achievement orientation. The processor 110 may further examine collaboration patterns and team dynamics to infer personality traits like extraversion and agreeableness. The processor 110 may also study carcer paths to identify potential personality traits linked to leadership, innovation, or stability. The plurality of employee personality profiles 427 may be generated based on the one or more personality assessment frameworks (for example, Big Five, CliftonStrengths, HEXACO, Myers-Briggs Type Indicator (MBTI), Enneagram, DiSC, etc.). The processor 110 may further deploy techniques like factor analysis, cluster analysis, or machine learning algorithms to identify underlying personality dimensions. Furthermore, NLP and sentiment analysis may also be deployed to analyze textual data (for example, performance reviews and emails) to extract personality-related keywords and phrases.

Furthermore, the plurality of employee personality profiles 427 may be used by the processor 110 to generate a plurality of employee anti-personality profiles 429 (for example, ALEX_AP 429a, SANDRA_P 429b, JASON_P 429c, and JANET_P 429d) by reversing values of parameters used in the selected one or more personality assessment frameworks. Furthermore, the processor 110 may then generate a plurality of anti-employee digital twins 431 (for example, ALEX_AT 413a, SANDRA_AT 431b, JASON_AT 431c, and JANET_AT 431d). The plurality of anti-employee digital twins 431 may take several different forms that may be identical or complementary to the several forms discussed in view of the plurality of employee digital twins 120. This feature can help balance skillsets and viewpoints. Similar to the first communications mesh 210, the second communications mesh 220, the plurality of virtual agents 116, the at least one digital twin 118, and the plurality of employee digital twins 120, the plurality of anti-employee digital twins 431 can also be configured in a variety of ways, including electronic circuitries, digital arithmetic and logic blocks, and memory systems in combination with software, firmware, and embedded technologies as discussed in the preceding discussion.

When considering the application of Multi-Objective Optimization (MOO) to the plurality of anti-employee digital twins 413, the MOO would use an anti-employee digital twin as a critical input to optimize organizational strategies designed to mitigate risks or enhance resilience. In other words, the operational workflows are modified through MOO to mitigate the negative impacts of traits represented by the plurality of anti-employee digital twins 431. The anti-employee digital twin models undesirable traits like low productivity, high resistance to change, or increased attrition risk. Therefore, MOO in this context would be deployed to find the optimal set of interventions, policies, or resource allocations that either minimize the negative impact the anti-traits could have on organizational outcomes or maximize the ability of the organization to withstand the anti-traits.

For instance, in an example scenario where an organization wants to introduce a significant technological change. The plurality of anti-employee digital twins 431, each simulating different facets of resistance (for example, low adaptability, high skepticism, poor learning agility), could be used. MOO could then be applied to determine the optimal change management strategy. The objectives might include (1) minimizing the overall time to adoption, (2) minimizing training costs, and (3) maximizing employee satisfaction during the transition, all while accounting for the simulated resistance from the plurality of anti-employee digital twins 431. The MOO algorithm may explore various combinations of training intensity, communication frequency, leadership involvement, and incentive structures. The output would be a Parcto front of optimal strategies, showing the trade-offs. For example, a very fast adoption comes at a higher training cost and lower initial satisfaction, whereas a slower, more inclusive approach might cost less but take longer. The plurality of anti-employee digital twins 431 is a challenge that the optimization algorithm must overcome, leading to an optimally designed change process.

Another application may involve optimizing team resilience and project risk management. In an example scenario of forming a project team where some members might exhibit traits (as modeled by the plurality of anti-employee digital twins 431) that could lead to communication breakdowns, missed deadlines, or quality issues. MOO could be used to identify the optimal mix of support mechanisms, oversight levels, or complementary skill sets from other employees (whose positive traits might counterbalance the anti-traits) to achieve objectives like (1) maximizing project success rate, (2) minimizing project overruns (Objective 2), while also (3) minimizing the need for external interventions. The plurality of anti-employee digital twins 431 would provide the stressors in the simulation, and MOO helps find the most efficient and effective ways to design teams and processes that are robust against these potential human-factor challenges.

The main advantage of creating the plurality of anti-employee digital twins 431 lies in their ability to serve as effective diagnostic and predictive tools for organizational health and risk management. By simulating the “worst-case scenarios” or “undesired states” across a workforce, the plurality of anti-employee digital twins 431 could help the organization proactively identify vulnerabilities, anticipate negative trends, and develop robust mitigation strategies before they manifest in the real world. For instance, if an employee digital twin indicates high collaboration and innovation, its anti-employee digital twin might model isolation and resistance to new ideas, helping to pinpoint potential areas where team dynamics could falter or where specific interventions might be needed to foster inclusion and adaptability. In another example, if a top salesperson is extroverted and relationship-driven, their anti-employee digital twin would be introverted and analytical. By replacing the salesperson with their anti-employee digital twin in a simulation, it may be revealed if the sales team is too dependent upon their specific personality type, thereby identifying vulnerabilities before they become actual problems.

Furthermore, the plurality of anti-employee digital twins 431 could be implemented for stress testing organizational policies and initiatives. When a new policy, team structure, or technological rollout is being considered, running simulations against a population of anti-employee digital twins could reveal potential friction points, unexpected resistance, or areas where communication might break down. This allows leaders to refine their strategies, build in safeguards, and prepare targeted support for groups or individuals most likely to react negatively, thus increasing the success rate of organizational changes. For example, if an anti-employee digital twin modeled for low adaptability consistently fails to integrate with a new software system during a simulation, it signals a need for more intensive training or personalized support for employees exhibiting similar traits, rather than assuming a one-size-fits-all approach will succeed. This capability extends to identifying potential points of friction or single points of failure in complex operational workflows, where the inverse of ideal employee behavior (for example, procrastination, lack of attention to detail) could lead to significant bottlenecks or errors.

Also, the plurality of anti-employee digital twins 431 could serve as a training ground for leadership and management development. By simulating interactions with these inverse personalities, managers could practice conflict resolution, motivational techniques, or difficult conversations in a safe, virtual environment. It provides a unique opportunity to understand the drivers behind challenging behaviors and to hone leadership skills necessary to navigate complex human dynamics within the workplace.

It is to be noted here that biases can creep into AI-based virtual agents, employee digital twins, anti-employee digital twins, and workplace digital twins at various stages of development and use. Several steps can be deployed to ensure that such biases can be mitigated as much as possible within the constraints of the technology available. For example, AI models can be trained on diverse datasets that represent the variety of people and experiences within an organization. This helps mitigate bias based on factors like gender, race, age, or disability. Cleaning of training data to identify and remove biases that might be present. This could involve manually reviewing data or using bias detection algorithms. Human experts may be involved in the data collection and training process to identify potential biases and ensure that the data accurately reflects the organization and the operational workflows. When designing the AI models, fairness metrics may be incorporated to assess potential biases in the outputs. These metrics could track factors like decision fairness or outcome fairness across different demographics. Another approach is to build explainable models, allowing an understanding of how the AI arrives at its decisions. This helps to identify and address any biases embedded in the logic of the model.

During deployment and use, the performance of the AI systems can be continuously monitored for signs of bias. This could involve analyzing outputs or gathering user feedback. Human review processes may be implemented for critical decisions made by AI-based systems. This allows humans to identify and correct for biases before they impact real-world outcomes. Furthermore, employees may be educated about potential biases in AI systems and how to identify and report them. This fosters a culture of awareness and helps mitigate bias throughout the organization. Other factors may include awareness of inherent biases in the algorithms used, regular review processes, and practicing a fair amount of transparency within the organization. By following these strategies, proactive steps can be taken to reduce bias in AI-based virtual agents, employee digital twins, anti-employee digital twins, and workplace digital twins. This ensures these systems operate fairly and ethically, benefiting the employees and the organization as a whole.

Furthermore, to address ethical concerns, Explainable AI (XAI) techniques may be integrated with the plurality of virtual agents 116, the plurality of employee digital twins 120, the plurality of anti-employee digital twins 431, and the at least one workplace digital twin 118, making their decision-making process more transparent to human agents. Some common methods used in XAI include feature importance (identifying which inputs had the most impact on the output), Local Interpretable Model-agnostic Explanations (LIME) (creating simplified models to explain individual predictions), partial dependence plots (visualizing how features influence the output), counterfactual explanations (showing how input data would need to change to produce a different output).

Referring to FIG. 3, at Step 310, the processor 110 enables communication amongst a plurality of disparate groupings for enabling execution of the operational workflows. The plurality of disparate groupings are generated by selecting a plurality of entities from one or more of the plurality of employee devices 102, the plurality of virtual agents 116, the plurality of employee digital twins 120, or the at least one workplace digital twin 118. In several embodiments, one or more of the plurality of entities may further be selected from the plurality of anti-employee digital twins 431. The communication may be enabled through one or more of the first communications mesh 210 or the second communications mesh 220. In several embodiments, the communication may be enabled amongst one or more employees using their respective employee devices and one or more digital twins 120. In several embodiments, the communication may be enabled amongst one or more employees using their respective employee devices, one or more virtual agents, and one or more anti-employee digital twins.

In several embodiments, the communication may be enabled amongst one or more virtual agents, the at least one workplace digital twin 118, and the plurality of anti-employee digital twins 431. In several embodiments, the communication may be enabled amongst the plurality of employee digital twins 120, one or more anti-employee digital twins, one or more virtual agents, one or more employees using their respective employee devices, and the at least one workplace digital twin 118. In several embodiments, the communication may be enabled amongst the plurality of employee digital twins 120 and the at least one workplace twin 118. Many such combinations of disparate groupings may be enabled at different levels of the organization, without departing from the scope of the disclosure.

At the individual level, actions of an employee within an operational workflow can be continuously monitored and analyzed by their respective employee digital twin. The employee digital twin, enriched by data from the HRIS server 122 and the enterprise server 126, can track progress, identify bottlenecks, and compare actual performance against optimal paths derived from multi-objective optimization. Concurrently, the plurality of virtual agents 116 (for example, virtual personal assistants or virtual coaches) can interact directly with the employee, providing real-time guidance, reminding them of best practices, offering micro-training modules to address skill gaps identified by their twin, or even flagging potential burnout based on workload analysis from the employee digital twin. For simulation, the employee digital twin can be used to model the impact of new tools or processes on individual productivity or well-being before actual implementation, while plurality of anti-employee digital twins 431 can be deployed to simulate worst-case scenarios, revealing how common human errors or suboptimal personality traits might derail a task, thus helping design more robust processes or targeted support.

At team and department levels, the collective behaviors of the plurality of employee digital twins 120, augmented by the plurality of virtual agents 116, may provide practical insights into collaborative workflows. The at least one workplace digital twin 118, particularly in spatial and environmental forms, can model the physical environment, showing how team members interact in shared spaces or how environmental factors affect their collective performance. Simulation scenarios can explore different team compositions (using the plurality of employee digital twins 120 with various personality profiles and skill sets), test the efficiency of new collaboration tools (simulated interactions via virtual agents), or even model the impact of a departmental restructuring on communication flow, leveraging the network analysis capabilities from the communications server 134. The plurality of anti-employee digital twins 431, when combined in a simulated team, could highlight potential points of internal conflict, communication breakdowns, or skill deficiencies that could jeopardize team objectives, allowing managers to proactively intervene or refine team structures. The plurality of virtual agents 116, in this context, can act as facilitators, mediators, or even autonomous task executors within the workflow, streamlining communication and automating routine collaborative steps.

At the broader reporting and business unit levels, the aggregation of insights from individual employees and teams of employee digital twins, coupled with the at least one workplace digital twin 118, allows for strategic optimization of entire operational workflows. The at least one workplace digital twin 118 can simulate the impact of large-scale changes like office redesigns or the deployment of new IoT devices on overall operational efficiency and resource utilization. The plurality of virtual agents 116 can take on higher-level roles, acting as virtual project planners and allocators, using aggregated employee digital twin data to optimize resource deployment across multiple projects, balance workloads across departments, and align human capital with strategic business unit goals. The plurality of anti-employee digital twins 431 can be used to identify systemic vulnerabilities in workflows due to potential widespread resistance to change or a lack of specific competencies across an entire unit, informing comprehensive training programs or strategic hires.

There are several advantages to this approach. The advantages include enhanced efficiency through optimized resource allocation and proactive bottleneck identification, improved employee well-being and engagement through personalized support and workload balancing, accelerated innovation by identifying optimal team compositions and fostering skill development, proactive risk mitigation by simulating negative scenarios and identifying vulnerabilities, and ultimately, data-driven decision-making that leads to more resilient, adaptive, and high-performing organization. Furthermore, the aforementioned approach may be instrumental in revealing true costs of workforce changes (for example, headcount reduction, restructuring, merger, acquisition, cutting departments, combining teams, staffing a team for a project), thereby solving multi-billion-dollar optimization problems.

The combined use of the plurality of virtual agents 116, the plurality of employee digital twins 120, the plurality of anti-employee digital twins 431, and the at least one workplace digital twin for executing and simulating operational workflows offers a framework that operates distinctly in exploratory, advisory, and optimization modes.

In the exploratory mode, the method 300 functions as a dynamic sandbox for understanding potential outcomes and identifying emergent patterns without real-world risk. For instance, an organization could simulate a new operational workflow across a specific department within the at least one workplace digital twin 118. This simulation would involve the plurality of employee digital twins 120 (representing the actual workforce's skills, capacities, and personality profiles) interacting with the new process, guided by the plurality of virtual agents 116 acting as virtual trainers or task managers within the simulated environment. By observing how the digital entities perform under various conditions, such as increased workload or resource constraints, the method 300 can uncover unforeseen bottlenecks, identify skill gaps before they become critical, or predict potential points of friction. Furthermore, by introducing the plurality of anti-employee digital twins 431 into the simulations, the exploratory mode becomes adapted for stress-testing. One could observe how a workflow fares if certain employees exhibit low adaptability, high absenteeism, or resistance to new tools, revealing vulnerabilities and informing preemptive design changes or targeted support strategies. This mode is about gaining insights into “what-if” scenarios, understanding complex interdependencies, and unveiling emergent behaviors within the operational system before committing to real-world changes.

The advisory mode leverages the insights gained from the exploratory phase and real-time operational data to provide actionable recommendations and guidance. Here, the plurality of virtual agents 116 may play a central role, drawing upon the continuous monitoring and analysis provided by the various digital twins. For example, an employee digital twin detecting signs of impending burnout (based on workload from the enterprise server 126 and communication patterns from the communications server 134) could trigger a virtual agent (for example, a virtual coach) to advise the employee on stress management techniques or suggest a brief break. Concurrently, the at least one workplace digital twin 118 could advise facilities management on optimizing office layouts to improve collaboration based on real-time occupancy data, or suggest adjusting environmental controls to enhance comfort in specific zones. When integrated with operational workflows, the plurality of virtual agents 116 can provide real-time suggestions to human employees for task prioritization, recommend the best internal resources or human experts based on the needs of the employee digital twin and collective knowledge of the organization, or even guide them through complex procedural steps. The plurality of anti-employee digital twins 431, while not directly advised, informs the advice given to managers or team leads on how to best support or manage team members who might be exhibiting challenging behaviors, providing context and suggested approaches for human intervention.

In the optimization mode, the method 300 may be deployed to refine and improve operational workflows and human capital deployment to achieve specific, quantifiable objectives, often employing multi-objective optimization (MOO). For instance, the method 300 might use MOO to optimize resource allocation for a critical project, balancing objectives like minimizing cost, maximizing project completion speed, and enhancing team satisfaction. The plurality of employee digital twins 120 provides the detailed, dynamic profiles of available human resources (skills, availability, preferences, past performance), while the at least one workplace digital twin 118 offers data on available physical resources (meeting rooms, specialized equipment). The plurality of virtual agents 116, acting as virtual project planners or resource allocators, would implement the solutions generated by MOO, dynamically assigning tasks, suggesting optimal team compositions, or reallocating resources in real-time based on live operational data feeds. MOO could be used to optimize risk mitigation strategies, finding the most efficient ways to design a workflow or structure a team such that the negative impact of specific anti-traits, of the plurality of anti-employee digital twins 431, is minimized, thus optimizing for resilience.

In the grouping involving one or more of the plurality of employees 101, the plurality of employees 101 may utilize the plurality of client applications 103a, 103b, 103c, and 103d installed with the plurality of respective employee devices 102 (for example, 102a, 102b, 102c, and 102d). In several embodiments, the plurality of client applications 103a, 103b, 103c, and 103d may be represented as dashboard applications with features supporting audiovisual interaction and text-based interactions with the plurality of virtual agents 116, the plurality of employee digital twins 120, and the at least one workplace digital twin 118. In several embodiments, each one of the plurality of virtual agents 116, the plurality of employee digital twins 120, the plurality of anti-employee digital twins 431, and the at least one workplace digital twin 118 may manifest as one or more combinations of an instant messaging chatbot, a voice-based chatbot, or a visual 3-Dimensional avatar or any other visual representations, through the plurality of client applications 103a, 103b, 103c, and 103d.

To implement text messaging capabilities, the processor 110 may implement WebSocket for real-time text communication in web applications. Furthermore, the processor 110 may deploy tools such as Firebase Realtime Database, Pusher, or Socket.io for real-time chat implementation. Furthermore, the processor 110 may leverage rich text editors such as Quill, TinyMCE, or Draft.js for web applications and use libraries like Trix Editor or RichEditorView for mobile applications. Furthermore, databases like Firebase Firestore, MongoDB, or PostgreSQL may be used to store chat messages. The processor 110 may implement efficient querying and indexing to handle large volumes of text data. For audio interaction support, the processor 110 may use APIs like Web Audio API for web applications, and for mobile apps, the processor 110 may use platform-specific libraries such as AVFoundation for iOS and MediaRecorder for Android. Furthermore, desktop applications can utilize libraries like PortAudio or use built-in system APIs. The processor 110 may further integrate libraries for audio processing and manipulation, such as SoX or FFMPEG, and implement noise reduction, echo cancellation, and other audio enhancements if necessary. For streaming, the processor 110 may use protocols like WebRTC for real-time audio communication and third-party services such as Twilio, Agora, or Jitsi for the implementation of real-time audio features.

For video interaction support, the processor 110 may utilize HTML5 <video> element or WebRTC for web applications, platform-specific APIs for mobile apps, such as AVFoundation for iOS and MediaRecorder for Android, and libraries like OpenCV or VLC's libVLC for desktop applications. The processor 110 may further integrate video processing libraries such as OpenCV for tasks like face detection, object tracking, and video manipulation. For streaming, the processor 110 may use WebRTC for real-time video communication or third-party services such as Twilio Video, Agora, and Jitsi. The video files can be stored using cloud storage services like AWS S3, Google Cloud Storage, or Azure Blob Storage, and Content Delivery Networks (CDNs) can be used to ensure efficient delivery of video content.

FIG. 4D illustrates an implementation 450 of a client application 103a as a dashboard for an employee named Alex on an employee device 102a, in accordance with an embodiment of the present disclosure. The dashboard includes several segments indicating several performance parameters and personality traits specific to Alex. For example, the dashboard includes a personality traits segment 452, a CliftonStrenghts segment 454, a CVI segment 456, a preferences segment 458, a 3-Dimensional (3D) virtualization 460 of AGENT_C 116c, and a messaging space 462 to allow instant messaging between the AGENT_C 116c and the employee Alex. The 3D virtualization 460 of AGENT_C 116c allows the employee ALEX to have a more relatable conversation between AGENT_C 116c and themselves. Moreover, the 3D virtualization 460 allows audiovisual interactions between the employee ALEX and AGENT_C 116c. A person skilled in the art would appreciate that employees are more receptive to audiovisual interactions in combination with text-based interactions when compared with text-based interactions alone.

The messaging space 462 allows text messages to be exchanged between AGENT_C 116c and the employee ALEX. It is to be noted here that messages and responses of AGENT_C 116c may be personalized to suit the performance parameters and personality traits specific to ALEX through implementations of machine learning algorithms, multi-agent platform 147, the first LLM 139, and the second LLM 143. In that regard, AGENT_C 116c may also utilize an employee personality profile (ALEX_P) 427a corresponding to ALEX to personalize a text message shared with ALEX. Furthermore, AGENT_C 116c may deploy NLP and sentiment analysis on responses presented by ALEX to further personalize subsequent text messages exchanged with ALEX. The personalized text message with NLP and sentiment analysis deployed reads as “Alex, your innovative approach is spot on. To strengthen the proposal, add detailed budget justifications and a clear timeline. Let's discuss AI integration for customer feedback in our next meeting.”

The message depicted in FIG. 4D without personalization may have come about as “Your project proposal is good, but it needs more details in the budget section and a stronger risk management plan”, which, given the personality traits and other parameters corresponding to ALEX, would not have inspired a positive or a wholehearted response from ALEX. Similarly, in several embodiments, communications between the employee ALEX and any entity selected from a group consisting of the plurality of virtual agents 116, the plurality of employee digital twins 120, the plurality of anti-employee digital twins 431, and the at least workplace digital twin 118 may be customized based on the respective employee personality profile (ALEX_P) 427a associated with the employee ALEX. Another virtual agent AGENT_B 116b may be utilized as a communications-assist agent for assisting communication between two employees of the organization.

FIG. 4E illustrates an implementation 475 of the virtual agent AGENT_B 116b acting as the communications-assist agent during an exchange of messages between two employees SANDRA and JASON, of the organization, in accordance with an embodiment of the present disclosure. SANDRA and JASON are communicating with each other through their respective client applications 103b and 103c, respectively, in a messaging space 477. AGENT_B 116b has access to respective employee personality profiles (JASON_P) 427c and (SANDRA_P) 427b of JASON and SANDRA, and the messaging space 477. The respective employee personality profiles 427c and 427b allow AGENT_B 116b to provide personalized suggested responses 479 to SANDRA and JASON on their respective client applications 103b and 103c. The personalized suggested responses 479 are generated to suit the personality of a message receiver employee based on the respective employee personality profile (for example, SANDRA_P 427b for SANDRA) of the message receiver employee. In this manner, a message sender employee (for example, JASON) would be able to communicate effectively and efficiently with the message receiver employee and enhance the engagement of both employees, JASON and SANDRA. In addition to the plurality of employee personality profiles 427, by further leveraging NLP libraries such as SpaCy, NLTK, Hugging Face Transformers, language models such as GPT-3, BERT, T5, spell checkers such as PySpellChecker, Hunspell, LanguageTool, and APIs such as Google Cloud Natural Language API, Microsoft Azure Text Analytics, Grammarly API,AGENT_B 116b may also further be able to provide options of autofill and autocorrect in the suggested responses 479.

It is further to be noted that similar dashboards may be created for other aspects, with different employees in different positions. For example, managerial-level employees may have a dedicated dashboard with access controls where they may be able to simulate operational outcomes of planned operational workflows by interacting with the plurality of virtual agents 116, the plurality of employee digital twins 120, the plurality of anti-employee digital twins 431, and the at least one workplace digital twin 118. Furthermore, the managers may be able to communicate critical feedback to their team members through the plurality of virtual agents 116 or the plurality of employee digital twins 120, enabling the employees to be more amenable to receiving feedback and taking corrective actions if necessary.

Furthermore, in several embodiments, the processor 110 may be enabled by the machine-readable instructions to receive personality traits input from one or more employees through one or more of the plurality of employee devices 102 and use the received personality traits to either generate a new personality profile of a virtual agent and modify an existing profile of a virtual agent. In that regard, in several embodiments, fields may be provided in the plurality of client applications 103a, 103b, 103c, and 103d, where an employee can enter the personality traits in accordance with the one or more personality assessment frameworks. The entered personality traits may then be used by the processor 110 to generate a new personality profile of a virtual agent (of the plurality of virtual agents 116) and modify an existing profile of a virtual agent (of the plurality of virtual agents 116).

In addition to the earlier example, with AGENT_C 116c acting as a central agent, employees as human agents may also be enabled to assign tasks to one or more virtual agents of the plurality of virtual agents 116. For example, the plurality of employee devices 102 through the plurality of client applications 103a, 103b, 103c, and 103d may be configured to assign tasks to the plurality of virtual agents 116. In that regard, the processor 110 would then be enabled by the machine-readable instructions to receive task assignments from one or more of the plurality of employee devices 102 and assign the task to one or more of the plurality of virtual agents 116.

In several embodiments, the plurality of employee digital twins 120 and the plurality of anti-employee digital twins 431 may be utilized by the processor 110 to simulate a plurality of decision scenarios within the organization. The plurality of decision scenarios may include layoff and productivity strategies (for example, reducing headcount by 10%), team optimization (for example, creating effective teams for a given geographical region), manager-employee matching (for example, promoting an individual to a managerial position), organizational restructuring (for example, merging two business verticals or Strategic Business Units (SBUs)), business unit analysis (for example, strategic divestiture planning), succession planning (for example, losing or replacing a high-performing employee), and project-based team structuring (for example, dynamic resource allocation).

When considering scenarios like layoff and productivity strategies, the plurality of employee digital twins 120, provided with detailed performance metrics, skill sets, salary data, and even well-being indicators from the HRIS server 122 and the enterprise server 126, can be used to simulate the impact of different workforce reduction criteria. For instance, a simulation might explore the effects of laying off the bottom 5% of performers versus eliminating specific departmental roles, measuring the resulting impact on overall productivity, skill retention, and remaining employee morale (inferred from communication patterns). Conversely, the plurality of anti-employee digital twins 431, representing individuals with lower productivity, higher attrition risk, or specific skill deficiencies, could be targeted in these simulated layoffs to observe the optimal positive impact on overall organizational efficiency and cost savings, allowing organizations to fine-tune their strategies to maximize output with minimal negative ripple effects.

For team optimization and project-based team structuring, the combination of the plurality of employee digital twins 120 and the plurality of anti-employee digital twins 431 becomes very useful. The plurality of employee digital twins 120 may provide rich profiles of skills, experience, personality traits (from analyzed communication data), and past performance. Multi-objective optimization, discussed earlier, can then run simulations to form optimal teams by balancing diverse skills, compatible working styles, and achieving specific project objectives. The plurality of anti-employee digital twins 431 may be utilized for stress-testing these proposed teams. For example, a simulation might introduce an anti-employee digital twin characterized by low agreeableness or high conscientiousness (manifesting as micromanagement) into a highly collaborative team of employee digital twins. This would allow the simulation to predict potential communication breakdowns, conflicts, or reduced team cohesion, prompting managers to either adjust the team composition pre-emptively or to provide specific leadership training to mitigate such risks.

FIG. 4F illustrates a Graphic User Interface (GUI) 480 depicting a plurality of team optimization modes, in accordance with an embodiment of the present disclosure. The GUI 480 includes three tabs, viz., a virtual agents tab 481A, a digital twin/anti-twin tab 481B, and a team optimization tab 481C. The team optimization tab 481C depicts three modes of team optimization, including an exploratory mode 482A enabling drag and drop scenario testing by manual addition of a plurality of team members of a team in entirety, an advisory mode 482B including receiving AI recommendations for building at least a part of a team based on a plurality of predetermined organizational goals, and an optimization mode 482C including automatic optimal discovery of the plurality of team members based on the plurality of predetermined organizational goals. In the exploratory mode 482A for team optimization, the processor 110 would enable an interactive, real-time “what-if” simulator, allowing authorized personnel such as HR professionals, project managers, or team leads, to dynamically assemble and test various team configurations. The interface may present a pool of the plurality of employee digital twins 120 and the plurality of anti-employee digital twins 431 for the authorized person to choose from and add to a team canvas.

Once a prospective team is assembled by the authorized personnel, the processor 110 may initiate a simulation of an operational workflow relevant to one or more intended team objectives, such as a software development sprint, a marketing campaign, a customer service resolution process, etc. During the simulation, the selected employee digital twins or anti-employee digital twins would interact according to their profiled attributes. For instance, an employee digital twin with high conscientiousness might prioritize tasks and adhere strictly to deadlines in the simulation, while an anti-employee digital twin with low agreeableness might simulate communication breakdowns or conflicts within the virtual team. In several embodiments, the processor 110 may then run a plurality of iterations of the operational workflow, factoring in different aspects like unforeseen challenges, resource availability, or changes in project scope.

Expected results from the simulations may then be dynamically generated and visualized, providing immediate feedback to the authorized personnel. The expected results may include projected metrics such as estimated project completion time, predicted quality of output, anticipated team cohesion (inferred from simulated communication patterns and personality compatibility), potential stress levels or burnout risk for individual team members, and even predicted cost efficiency. The processor 110 may further highlight potential bottlenecks, suggest areas where specific skills are lacking, or flag predicted interpersonal friction.

In the advisory mode 482B for team optimization, the simulation may change from a purely user-driven exploration to an AI-assisted recommendation program, designed to help build high-performing teams based on a plurality of predefined organizational goals. The processor 110 may be configured to receive specific team objectives and desired outcomes from the authorized personnel, such as “maximize innovation for a new product launch,” “minimize project duration for a critical client delivery,” or “build a resilient support team for high-stress periods.” In several embodiments, the plurality of predetermined organizational goals may translate into the objectives for a Multi-Objective Optimization (MOO) model. The AI-assisted recommendation program may leverage comprehensive data from the plurality of employee digital twins 120 and the plurality of anti-employee digital twins 431.

For instance, if a predetermined organizational goal is maximizing innovation, the AI-assisted recommendation program might recommend a team with diverse personality traits (for example, a mix of high openness and high conscientiousness) and complementary skill sets. If a predetermined organizational goal is minimizing project duration, the AI-assisted recommendation program might prioritize employee digital twins with high past performance in similar projects and specific technical proficiencies. The processor 110 may also proactively include one or more anti-employee digital twins in considerations, recommending strategies to mitigate their potential negative impact by pairing them with employee digital twins known for strong leadership or mentoring capabilities.

FIG. 4G illustrates a GUI 483 for simulating operational outcomes based on a given combination of a list 486 of team members and the plurality of predetermined organizational goals, in accordance with an embodiment of the present disclosure. In that regard, the GUI 483 may be applicable to one or more of the exploratory mode 482A or the advisory mode 482B. The GUI 483 includes an identification 484 for a scenario (for example, “SCENARIO X”) being simulated. The GUI 483 further includes a “SELECT TEAM” interface element 485 that would allow the authorized personnel to add team members selected from the plurality of employee digital twins 120 and the plurality of anti-employee digital twins 431. The GUI 483 further depicts a list 486 of team members. The list 486 further has an option of adding further team members. In one embodiment, list 486 may be populated entirely manually by the authorized personnel in the exploratory mode 482A. In several alternate embodiments, at least one team member of the list 486 may be added based on recommendations provided by the AI-assisted recommendation program, in the advisory mode 482B.

The GUI 483 further includes a “RUN SIMULATION” interface element 487 that allows the authorized personnel to instruct the processor 110 to simulate the operational workflow based on the list 486 and the plurality of predetermined organization goals. The processor 110, in that regard, may run one or multiple iterations of the simulation. Furthermore, the GUI 483 depicts predicted outcomes 488 generated by simulating the operational workflow in one or multiple iterations. In several embodiments, the predicted outcomes 488 may include quantitative metrics like estimated project duration, resource utilization efficiency (for example, man-hours, equipment usage), and cost projections. Qualitatively, the predicted outcomes 488 may further include team cohesion and collaboration effectiveness (inferred from simulated communication patterns and personality compatibility), highlight potential bottlenecks or friction points arising from conflicting working styles or skill gaps, and project the likelihood of achieving key performance indicators (KPIs). Furthermore, the predicted outcomes 488 may include individual employee well-being impacts (for example, potential for burnout, job satisfaction), and if anti-employee digital twins were included, quantification of potential risks or negative impacts (for example, communication breakdowns, delays, quality issues), and the effectiveness of mitigation strategies.

FIG. 4H illustrates a GUI 490 illustrating predicted outcomes 493 and 496 from simulations for two distinct team combinations 491 and 494, for a given scenario “SCENARIO A”, in accordance with an embodiment of the present disclosure. In a first team combination 491, a first list 492 of team members includes a combination of employee digital twins or anti-employee digital twins named “Sarah”, “John”, and “Devon”. First predicted outcomes 493 recite a productivity value to be sixty-five (65), an engagement value to be seventy-eight (78), and cost savings to be USD fifty thousand (50,000). In a second team combination 494, a second list 495 of team members includes a combination of employee digital twins or anti-employee digital twins named “Sarah”, “Maya”, and “Devon”. Second predicted outcomes 496 recite the productivity value to be eighty-three (83), the engagement value to be eighty-nine (89), and the cost savings to be USD seventy-five thousand (75,000). Therefore, FIG. 4H indicates that the second team combination 494 is superior to the first team combination 491.

In the optimization mode 482C, the authorized personnel may only define the plurality of predetermined organizational goals. For instance, the plurality of predetermined organizational goals may include “achieve Project X with maximum innovation and minimum budget overruns,” or “staff a new business unit with balanced skill sets and high long-term retention potential”. In several embodiments, the high-level objectives may further be translated into the mathematical functions that the MOO algorithm would be utilized to optimize, considering various trade-offs. The processor 110 may then access the pool of the plurality of employee-digital twins 120 and the plurality of anti-employee digital twins 431.

The processor 110 executing the MOO algorithm, leveraging techniques like genetic algorithms or evolutionary computation, may explore a plurality of possible team combinations. The processor 110 may then iteratively evaluate each potential team combination against the plurality of predetermined organizational goals, striving to find the Pareto optimal set of solutions, i.e., teams where no objective can be improved without sacrificing another. For each candidate team configuration identified by the processor 110, an internal simulation program may be automatically invoked. The simulation program may run the relevant operational workflow with the proposed team combinations, generating predicted outcomes for metrics like project duration, quality, cost, team cohesion, individual well-being, and resilience to potential anti-employee digital twin behaviors. Output of the optimization mode 482C may include a prioritized list of optimally configured teams, each accompanied by simulated performance metrics against the original plurality of predetermined organizational goals. This allows the authorized personnel to choose from a set of the best possible teams, understanding the trade-offs inherent in each option. For example, the processor 110 might present “Team A”, which guarantees the fastest project completion but is slightly over budget, versus “Team B”, which is budget-friendly but takes a bit longer and has higher predicted employee satisfaction.

In either of the three modes, the exploratory mode 482A, the advisory mode 482B, and the optimization mode 482C, the team members of the team being generated may be selected from the pool of the plurality of employee digital twins 120 and the plurality of anti-employee digital twins 431. In one embodiment, the team members may only be selected from the plurality of employee digital twins 120. In another embodiment, the team members may only be selected from the plurality of anti-employee digital twins 431. In another further embodiment, the team members may be selected partly from the plurality of employee digital twins 120 and partly from the plurality of anti-employee digital twins 431. Furthermore, in either of the three modes, the processor 110 may employ one or more MOO strategies, such as evolutionary algorithms, Pareto-front solvers, or heuristic-based decision models, to evaluate competing workforce configuration scenarios. These strategies may operate over a composite score derived from workforce attributes (for example, skill coverage, personality-role alignment, cost impact, knowledge redundancy, engagement likelihood), which are extracted from digital twin models and compared across potential team arrangements. This allows dynamic scenario testing across diverse simulation modes (for example, using employee digital twins only, anti-employee digital twins only, or both), enabling organizations to view predicted operational outcomes prior to implementing changes.

Furthermore, in the exploratory mode 482A, communication from the authorized personnel may further involve direct manipulation and iterative querying. The authorized personnel would typically interact via a graphical interface, dragging and dropping from the plurality of employee digital twins 120 or the plurality of anti-employee digital twins 431 into a virtual team workspace. The authorized personnel might use natural language commands or predefined filters to search for specific types of digital twins (for example, “show mc all developers with strong Python skills and high conscientiousness”). As the team composition changes, the processor 110 would communicate predicted outcomes through dynamic visualizations and summaries, such as dashboards including text summaries, charts, graphs, heat maps, etc. If the authorized personnel want to understand why a certain outcome occurred or test a specific hypothesis, they might ask questions like, “What if I replace John with Sarah?” or “Show me the projected impact on team cohesion if this task takes longer than expected?” The processor 110 would then use Natural Language Understanding (NLU) to parse these queries, identify the entities (John, Sarah, task) and the requested actions, and then run the relevant mini-simulations or data comparisons to provide a deciphered response, often presented visually alongside a textual explanation.

In the exploratory mode 482A, where the authorized personnel are actively manipulating team compositions, the predicted outcomes may be presented in an interactive and dynamic dashboard configuration. As team members (employee or anti-employee digital twins) are added, removed, or swapped, the projected results would update in near real-time. This could involve live-updating charts and graphs showing predicted project duration, team cohesion scores, individual workload distributions, and potential skill gaps. A “heat map” visualization of the predicted communication flow or potential conflict areas (derived from personality traits) could be overlaid on a virtual team structure diagram. For instance, if adding an anti-employee digital twin with low agreeableness, a “conflict probability” gauge might immediately rise. Visual alerts or color-coding could highlight deviations from ideal performance or flag predicted risks like burnout for specific individuals. This configuration emphasizes immediate feedback and visual exploration of trade-offs, allowing the authorized personnel to intuitively understand the consequences of different team configurations through direct manipulation and instant visual response.

In the advisory mode 482B, communication becomes more conversational and goal-oriented. The authorized personnel would initiate interaction by stating the predetermined organizational goals for team building, often using natural language. For example, “I need a team for the ‘Quantum Leap’ project that can maximize innovation and minimize time to market,” or “Help me staff a customer support team that can handle high-stress situations with empathy.” The processor 110 may further utilize NLU and intent recognition to decipher the high-level organizational goals, mapping them to quantifiable objectives of the Multi-Objective Optimization (MOO) model. The processor 110 may then communicate recommendations by presenting a list of AI-generated team configurations, along with predicted performance metrics from simulation. The authorized personnel could then refine their request, asking follow-up questions like, “What if we prioritize cost savings over speed?” or “Can you suggest someone with strong leadership skills for this role instead?” The processor 110 may iteratively interpret the nuanced requests, adjusting the MOO parameters and re-running simulations to provide refined recommendations, effectively engaging in a human-AI collaborative design process.

For the advisory mode 482B, the presentation of the predicted outcome may shift to a comparative and recommendation-centric configuration. When the AI-assisted recommendation program provides a suggested team or a team member, the predicted outcomes may be presented side-by-side with a clear summary of the rationale behind the recommendation, linking specific digital twin attributes to predicted performance. This might involve a multi-criteria radar chart or spider diagram that visually scores the recommended team against various objectives (for example, speed, cost, innovation, team satisfaction), often alongside a baseline or “average” team for comparison. Detailed breakdowns could be presented for each recommended team member, showing their individual predicted contribution to the predetermined organizational goals. If multiple AI-recommended options exist, a Pareto front visualization might be employed, allowing the user to visually select their preferred trade-off point between conflicting objectives. The processor 110 might also generate “impact reports” that visually illustrate how key predicted outcomes (for example, project completion dates) shift with minor adjustments to the recommended team, empowering the authorized personnel to make guided refinements.

Furthermore, in the optimization mode 482C, the authorized personnel may primarily communicate about defining the predetermined organizational goals and strategic constraints, with less focus on direct team member selection. The authorized personnel might use a structured form or natural language input to specify predetermined organizational goals like “Optimize staffing for all Q3 projects to maximize efficiency and minimize employee burnout,” along with any hard constraints (for example, budget limits, mandatory skill sets). The processor 110 may then employ NLU to interpret the predetermined organizational goals and the strategic constraints, and translate them into the optimization problem for the MOO model. The communication back to the authorized personnel may be in the form of the automatically generated optimal team structures, accompanied by detailed reports and visualizations of the predicted outcomes and the trade-offs involved in each optimal solution found. While direct manipulation of team members may be less common in the optimization mode 482C, the authorized personnel might still query the processor 110 using natural language to understand the rationale behind a particular optimal solution (“Why was John chosen for this specific task in the optimal plan?”), requiring the processor 110 to provide explainable AI (XAI) insights by interpreting the decision-making process of the MOO model based on the underlying employee digital twin data.

Furthermore, in the optimization mode 482C, where the processor 110 automatically discovers optimal teams, the presentation of the predicted outcomes may focus on clear, concise, and actionable insights for decision-makers. The predicted outcomes for the top optimal teams (the Pareto front) may typically be displayed in a prioritized list or matrix configuration. Each optimal team configuration may be accompanied by a dashboard summarizing predicted performance across all predefined objectives, using scorecards, bar charts, or comparative tables. For instance, “Optimal Team A” might show “Project Duration: 90 days, Cost: $100K, Innovation Score: High,” while “Optimal Team B” shows “Project Duration: 100 days, Cost: $90K, Innovation Score: Medium.” Critical trade-offs may be visually highlighted, enabling high-level decision-makers to quickly grasp the implications of choosing one optimal solution over another. Furthermore, the processor 110 may also offer a “drill-down” capability, where clicking on a specific optimal team reveals a detailed breakdown of the team members (their digital twin profiles) and the underlying predicted interactions that led to the simulated outcomes, ensuring transparency and accountability for the automatically generated recommendations.

In all three modes for team optimization (exploratory 482A, advisory 482B, and optimization 482C), the communication between the authorized personnel and the server system 106 may be dynamically enriched to enable text-to-text, text-to-speech, speech-to-text, and speech-to-speech interactions, driven by Generative AI (GenAI) technologies, such as those offered by OpenAI or similar advanced LLMs. This multimodal approach aims to provide a natural, intuitive, and efficient user experience that caters to different preferences and contexts. For text-to-text interaction, which may be the foundational layer, the authorized personnel may input their queries, parameters, or refinement requests via typing. The processor 110, powered by a GenAI model (for example, GPT-4.5), would have Natural Language Understanding (NLU) capabilities to comprehend the intent, extract relevant entities (like employee names, skills, project goals), and process complex commands. The GenAI may then generate a detailed textual response, for example, for a predicted outcome, an AI-generated team recommendation, or an explanation of the optimization rationale.

Integrating speech-to-text (STT) allows the authorized personnel to communicate with the server system 106 verbally, transforming spoken words into textual input that the GenAI model can process. This capability, often leveraging models like OpenAI's Whisper or similar advanced speech recognition APIs, may be useful for hands-free operation, increased efficiency, and accessibility. A project manager could simply speak a query like, “Show me highly innovative teams for the new product launch,” or “What if we add Sarah to the marketing team and remove John?” The STT component transcribes this into text, which the GenAI model then interprets, runs the necessary simulations or optimization steps, and prepares a response.

Conversely, text-to-speech (TTS) functionality enables the processor 110 to vocalize responses, converting the GenAI-generated text into natural-sounding spoken audio. Utilizing advanced TTS models from OpenAI (like tts-1 or gpt-40-mini-tts) or other providers ensures that the synthesized voice is realistic, clear, and can even convey different tones or styles to match the context (for example, a formal tone for optimization results, a more conversational tone for advisory guidance). This allows users to receive information audibly while multitasking, or simply provides a more engaging and accessible user experience, especially when reviewing lengthy reports or complex simulations.

Also, speech-to-speech (STS) interaction combines STT and TTS in a continuous, bidirectional flow, creating a simulated conversational experience. The authorized personnel can speak a query, the STT transcribes the query, the GenAI processes the query, and generates a textual response, and then the TTS converts that text back into spoken audio for the authorized personnel. This creates a highly intuitive and immersive interface, almost like talking to a human expert. For instance, in the exploratory mode 482A, the authorized personnel user might verbally ask to “Simulate adding an anti-employee twin with low conscientiousness to this team.” The processor 110 would process the command, run the simulation, and then verbally respond, “Understood. Simulating now. Expected project completion time has increased by 15% due to predicted delays in task delivery.” The seamless, multimodal interaction, driven by advanced GenAI, significantly lowers the barrier to entry, accelerates decision-making, and creates a highly adaptive and natural user experience across all phases of team optimization.

The predicted outcomes from team optimization simulations may further be exportable in various document formats as comprehensive reports. The processor 110 may offer a range of common document formats to cater to diverse organizational needs. For instance, PDF (Portable Document Format) may be utilized for generating static, professional-grade reports that maintain formatting and are easily shareable across different platforms without concerns about modification. These PDF reports could include all the charts, graphs, tables, and textual summaries presented in the visual configurations, ensuring that a complete snapshot of the findings of the simulation is captured. For stakeholders who require flexibility for further analysis or data manipulation, CSV (Comma Separated Values) or Excel (XLSX) formats may also be made available. These formats would allow the authorized personnel to export the raw or aggregated numerical data from the predicted outcomes, enabling them to perform custom calculations, filter data, or integrate the data into their spreadsheets for detailed financial or operational planning.

Furthermore, for presentations or embedding into other documents, image formats (for example, PNG, JPEG) of specific charts or dashboards could be exported, providing high-quality visuals. For more programmatic integration or automated reporting, JSON (JavaScript Object Notation) or XML (Extensible Markup Language) exports of the structured prediction data may be highly beneficial, allowing other enterprise systems to programmatically consume and process the simulation results. The ability to generate these diverse reports ensures that the valuable insights derived from the simulations are not confined to the simulation platform alone but can be effectively disseminated, analyzed, and integrated into broader organizational decision-making workflows.

For project-based structuring, the plurality of virtual agents 116, the plurality of employee digital twins 120, and the plurality of anti-employee digital twins 431 can simulate task assignments, predict individual and collective completion times, and identify skill gaps that emerge only when certain combinations of personality and skill are put under project pressure. For example, if a project requires a highly innovative approach, the MOO might prioritize employee digital twins with high openness and creativity, while ensuring enough conscientious anti-employee digital twins are accounted for in the broader workforce analysis to prevent potential project roadblocks. The MOO aims to find the optimal assignment of specific tasks to individual employee digital twins and the formation of sub-teams, balancing project objectives (for example, minimizing duration, controlling cost, maximizing quality) with human-centric goals (for example, maximizing job satisfaction, balancing workload, fostering skill development).

In the simulation phase, the at least one workplace digital twin 118 may provide the environmental context, including available physical resources, collaborative spaces, and even the simulated impact of environmental factors. Within this simulated environment, the chosen employee digital twins and any strategically included anti-employee digital twins execute one or more operational workflows of the project. The plurality of virtual agents 116 may act as simulated project managers or facilitators within the simulation, orchestrating tasks and managing interdependencies. The simulation captures the predicted outcomes, such as estimated completion times, resource utilization, communication patterns, potential bottlenecks, and the overall impact on well-being and development of each participating employee. The iterative process of optimization and simulation would allow project managers to explore various project structures, refine team assignments, and proactively identify and mitigate risks associated with human factors, leading to highly effective, resilient, and human-optimized project execution plans.

In manager-employee matching, the personality traits derived from the plurality of employee digital twins 120 may be very useful. A simulation can test various manager-employee pairings, predicting the likelihood of a successful working relationship based on personality compatibility (for example, an employee digital twin with high openness paired with a manager twin showing high conscientiousness). An anti-employee digital twin, representing a manager with poor communication skills or an employee with high resistance to feedback, can be introduced to identify problematic pairings before they occur, allowing HR to make more informed placement decisions or to provide targeted coaching to managers. Similarly, organizational restructuring involves simulating the realignment of reporting lines and team formations on a larger scale. The plurality of employee digital twins 120 and the plurality of anti-employee digital twins 431 can model the impact of these changes on communication flows, knowledge transfer, and overall productivity.

The plurality of anti-employee digital twins 431 could be used to predict resistance points in the new structure or to identify areas where new leaders might struggle due to specific anti-traits within their new teams, guiding strategic leadership development and change management efforts. Moreover, for succession planning and business unit analysis, the plurality of employee digital twins 120 can simulate career paths, predict readiness for promotion, and identify future leadership potential based on their skills development and performance trajectories. The plurality of anti-employee digital twins 431 could be used to model the impact of losing key personnel without suitable successors or to simulate the cascading effects of a highly disengaged or underperforming segment of the workforce on the performance of an entire business unit, allowing for proactive talent development and risk mitigation strategies to ensure long-term organizational health.

The integrated framework discussed in foregoing discussion, leveraging the plurality employee digital twins 120, the plurality of anti-employee digital twins 431, the plurality of virtual agents 116, and the MOO, fundamentally supports organizations in exploring whether workforce reduction makes financial and organizational sense, and in making unavoidable workforce decisions more ethical and data-driven rather than based on favoritism or arbitrary criteria. For layoff and productivity strategies, the processor 110 enables granular, objective analysis. Instead of relying on gut feelings or personal biases, an organization can simulate the precise financial impact of different reduction scenarios by analyzing the productivity contribution, salary, benefits, and predicted operational impact of each employee digital twin. The processor 110 can assess which roles or individuals, if removed, would have the least detrimental effect on key projects or overall output, and conversely, which ones are indispensable. Moreover, the processor 110 allows for a more ethical approach by setting objective, data-driven criteria for workforce reduction (for example, performance metrics, skill redundancy, cost-to-value ratio, or even potential for reskilling) and simulating the outcomes of applying these criteria. The use of employee digital twins ensures that decisions are based on comprehensive, quantified data about an individual's actual contribution and potential, rather than subjective judgments or personal relationships, thereby mitigating favoritism.

For team optimization, manager-employee matching, and project-based team structuring, the processor 110 provides a robust, evidence-based alternative to traditional, often biased, decision-making. By simulating team dynamics with the plurality of employee digital twins 120 that encapsulate skills, working styles, and personality traits, organizations can objectively identify the most effective combinations for specific goals. When considering manager-employee pairings, the processor 110 can predict compatibility based on the one or more personality assessment frameworks, leading to more harmonious and productive relationships. This removes the influence of personal preference in assignments, ensuring that individuals are placed where they are most likely to thrive and contribute effectively, benefiting both the employee and the organization. The transparent, data-driven output from the MOO, which balances various objectives, makes it difficult for favoritism to play a role, as the rationale for each recommended pairing or team structure is explicitly backed by simulated outcomes and quantified data.

Furthermore, for organizational restructuring, business unit analysis, and succession planning, the processor 110 allows for strategic workforce decisions grounded in comprehensive data. Organizations can simulate different restructuring scenarios, predicting their impact on efficiency, communication flows, and overall talent distribution across business units. This enables a clear, data-driven understanding of the organizational sense of such changes. For succession planning, the plurality of employee digital twins 110 provides objective assessments of readiness for promotion and leadership potential, based on tracked skill development, past performance, and simulated scenarios, rather than relying solely on a subjective appraisal by a manager. By providing clear, quantifiable results and transparent rationales for decisions concerning talent allocation, workforce adjustments, and future leadership, the processor 110 minimizes the scope for favoritism, promotes fairness, and ensures that critical human capital decisions are made ethically, strategically, and with a clear understanding of their predicted organizational impact.

The implementation of the plurality of virtual agents 116, the plurality of employee digital twins 120, the plurality of anti-employee digital twins 431, and the at least one workplace digital twin 118 offers several advantages. For example, vast amounts of data may be processed to identify patterns and trends that human agents might miss. Forecasting of future trends and outcomes based on historical data is made possible, enabling proactive decision-making. Potential risks and opportunities can be identified, helping businesses mitigate threats and capitalize on new avenues. Repetitive tasks can be automated, freeing up human resources for more strategic work. Business processes can be analyzed to identify inefficiencies and suggest improvements. Information can be processed and decisions can be made much faster than humans. Customer data may be analyzed to offer personalized products, services, and recommendations. Operations can be streamlined and costs reduced by optimizing resource allocation. Fraudulent activities can be identified much in advance, preventing financial losses. Inventory management and logistics can be optimized, reducing costs. New product ideas can be generated and product design optimized. Market trends can be analyzed to identify new opportunities. Therefore, the organization can be provided with a competitive advantage by enabling the organization to outpace competitors.

Furthermore, in several embodiments, the processor 110 updates one or more of the at least one workplace digital twin 118, the plurality of virtual agents 116, the plurality of employee digital twins 120, and the plurality of anti-employee digital twins 431 periodically, in response to new data generation events, or based on differences between expected operational outcomes and actual observed operational outcomes. The at least one workplace digital twin 118 may be modified by implementing physical assets with sensors that collect real-time data on performance, usage, and environmental conditions. This data can be fed directly into the at least one workplace digital twin 118, providing a continuous stream of updates. Furthermore, at least one workplace digital twin 118 may be connected with business systems, such as CRM, ERP, and manufacturing software. This allows for automatic updates on inventory levels, production processes, customer interactions, and other relevant data points. Furthermore, the at least one workplace digital twin 118 may further be modified manually through scheduled updates for information that changes less frequently, such as employee data, equipment maintenance records, or new product specifications. Authorized personnel may be allowed to manually input changes or corrections to the at least one workplace digital twin 118. This can be useful for capturing qualitative data or unforeseen events that may not be automatically tracked by sensors.

Furthermore, regular monitoring of the data flowing into the at least one workplace digital twin 118 may be implemented to ensure accuracy and consistency. Furthermore, data-cleaning processes to identify and fix errors or inconsistencies may also be implemented. It is also important to maintain a version history to track changes over time. This allows the organization to revert to previous versions if necessary and understand the impact of changes made to the model. The machine learning algorithms may be deployed to analyze data from the at least one workplace digital twin 118 and identify deviations from normal operating conditions. This can be helpful for predictive maintenance or identifying potential issues before they occur. Advanced machine learning models can automatically learn from data and update the at least one workplace digital twin 118 based on patterns or insights they discover.

On the other hand, the plurality of virtual agents 116 may be retrained using new data, allowing the plurality of virtual agents 116 to learn and improve their performance over time. This can be done periodically or triggered by specific events. Fine-tuning can be performed using data specific to relevant tasks for which one or more of the plurality of AI agents 116 may be intended. For traditional virtual agents built with code, updates involve modifying the underlying codebase. This can involve bug fixes, introducing new functionalities, or optimizing existing behaviors. Some virtual agents are designed with modular components. Updates can be made by replacing specific modules with improved versions without affecting the entire system. Reinforcement learning virtual agents learn through trial and error by receiving rewards for desired behaviors. The reward system itself can be updated to guide the plurality of virtual agents 116 towards new goals or behaviors. In some scenarios, a simulated environment may be deployed. The simulations themselves can be updated to reflect new scenarios or challenges, prompting the plurality of virtual agents 116 to adapt and improve their decision-making.

The plurality of employee digital twins 120 may be modified through integration with the HRIS server 122 and the communications server 134. This allows for automatic updates whenever employee data in the HRIS changes, such as promotions, skills updates, or changes in contact information. Furthermore, employee activity may be tracked within the virtual workspace or organizational systems. This data can be used to update the plurality of employee digital twins 120 regarding the preferred working styles of the employees, most used tools, or areas of expertise. The plurality of employee digital twins 120 may also be modified through manual methods, such as by allowing employees to update their digital twin profiles. This empowers them to keep their skills, certifications, and preferred work styles current. Managers can be given access to update the plurality of employee digital twins 120 under their supervision. This allows them to reflect changes in employee roles, responsibilities, or project assignments. A regular review process may be established to assess the accuracy and completeness of data. This might involve checking for inconsistencies or outdated information.

The embodiments described above may be embodied as a monolithic application or embodied as a containerized microservices architecture, for example, Docker®, and orchestrated using a container orchestration platform, such as Kubernetes. For instance, one or more entities out of the plurality of virtual agents 116, the at least one workplace digital twin 118, the plurality of employee digital twins 120, or the plurality anti-employee digital twins 431 may be implemented as containerized microservices and orchestrated using the container orchestration platform. Combining containerization and microservices offers several advantages. Containers isolate microservices from the underlying operating system, allowing the microservices to run on any system with a container runtime. This makes applications easier to deploy across different environments, from development machines to production servers. Containers are lightweight and share the kernel of the host system, resulting in faster startup times and lower resource consumption compared to virtual machines. This efficiency allows the packing of more microservices onto a single server, maximizing resource utilization.

Since microservices are independent units, the microservices can be scaled up or down individually based on demand. Each microservice can be scaled independently based on its specific needs. If one part of the application experiences a surge in traffic, only that service may be scaled without affecting others. More instances of a microservice may be added to handle the increased load, distributing the workload across multiple machines. For resource-intensive microservices, the capabilities of individual instances may be enhanced by adding more CPU, memory, or storage.

By using container orchestration tools like Kubernetes, the scaling process can be automated for a highly responsive and elastic application. Microservices architecture promotes faster development cycles and easier deployments. Containers further streamline this process by providing a consistent environment for development, testing, and production. This agility allows developers to make changes and deliver new features quickly. If a single microservice crashes, it will not bring down the entire application. Containers isolate microservices from each other, preventing issues in one service from impacting others. This improves the overall stability and reliability of the application. Containers provide a familiar development environment for programmers. They can code, test, and deploy microservices using the same container image throughout the development lifecycle.

Kubernetes builds on the benefits of containerized microservices by providing a robust orchestration platform. Kubernetes automates deployments and scaling of containerized microservices. Several instances of a service can be defined to run based on resource usage or other metrics, ensuring the application scales seamlessly to meet fluctuating demands. Kubernetes ensures application uptime by automatically replacing failed or unresponsive container instances. This self-healing capability minimizes downtime and keeps the application running smoothly. Kubernetes provides built-in load balancing, distributing traffic efficiently across multiple instances of a microservice. This optimizes performance and prevents bottlenecks. Microservices can discover each other automatically within the Kubernetes cluster. This eliminates the need for manual configuration and simplifies communication between services. Kubernetes efficiently allocates resources between containerized microservices, preventing resource waste and ensuring optimal utilization. Kubernetes itself is portable and can run on various platforms, including public clouds, private clouds, and on-premises infrastructure. This flexibility helps avoid vendor lock-in and allows the movement of the application across environments as needed. Kubernetes integrates well with DevOps practices, enabling continuous integration and continuous delivery (CI/CD) pipelines. This automation streamlines the development and deployment process for microservices.

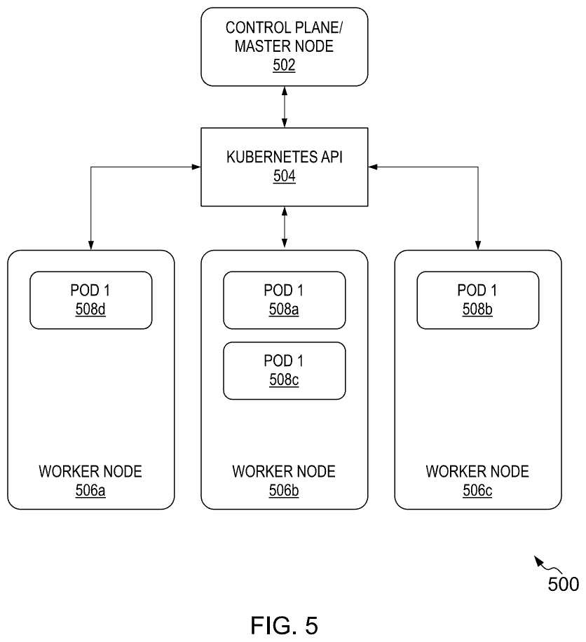

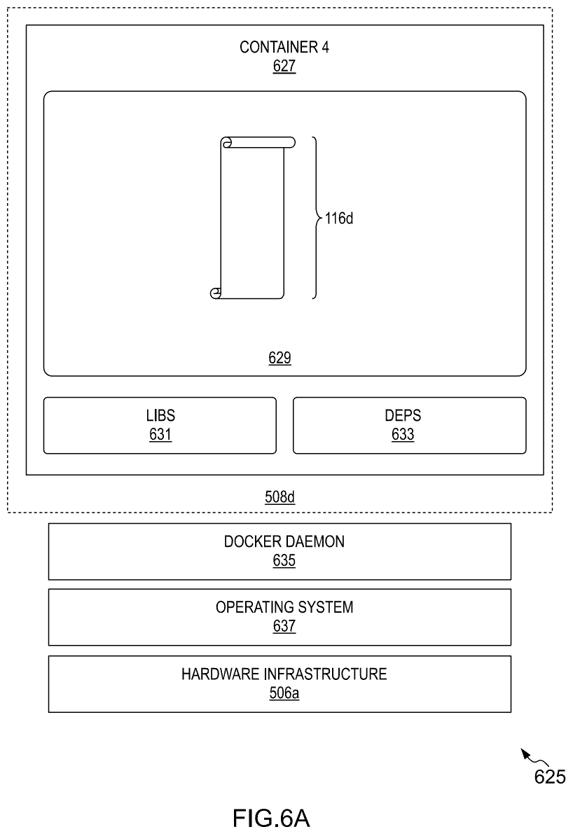

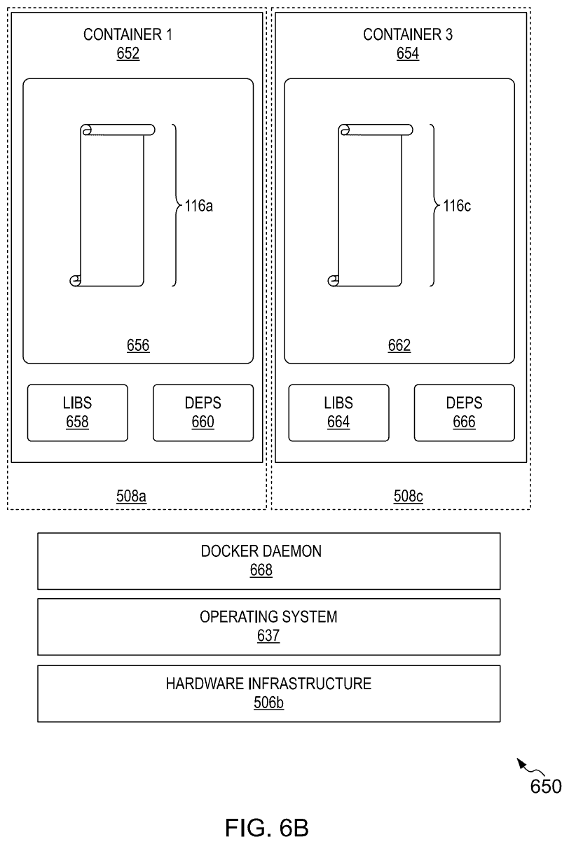

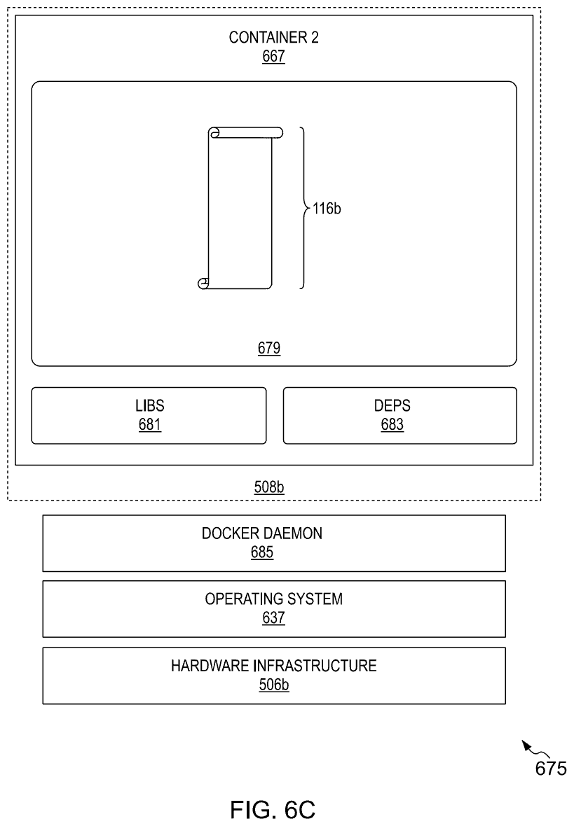

FIGS. 5 to 6C illustrate Kubernetes-based orchestration of the plurality of virtual agents 116 as containerized microservices, in accordance with an embodiment of the present disclosure. However, a person skilled in the art will appreciate that the same orchestration can be extended to the plurality of employee digital twins 120, the plurality of anti-employee digital twins 431, and the at least one workplace twin 118 without departing from the scope of the present disclosure.

FIG. 5 illustrates a Kubernetes cluster 500 (hereinafter also referred to as “the cluster 500”) for the orchestration of the containerized plurality of virtual agents 116, in accordance with an embodiment of the present disclosure. The cluster 500 includes a master node 502, also referred to as a control plane. Furthermore, the cluster 500 includes a plurality of worker nodes 506a, 506b, and 506c. The plurality of worker nodes 506a, 506b, and 506c may be physical machines or a combination of physical and virtual machines. Furthermore, the plurality of worker nodes 506a, 506b, and 506c communicate with the master node 502 through a Kubernetes API 504. In several embodiments, each worker node of the plurality of worker nodes 506a, 506b, and 506c may have its own Linux environment. Furthermore, each one of the plurality of worker nodes 506a, 506b, and 506c is configured to run one or more pods 508a, 508b, 508c, and 508d that are configured to host containers illustrated in FIGS. 6A to 6C.

The master node 502 maintains the overall health and configuration of the cluster 500. Furthermore, the master node 502 keeps track of the plurality of worker nodes 506a, 506b, and 506c, the one or more pods 508a, 508b, 508c, and 508d (groups of containers), and other resources. The master node 502 plays a crucial role in scheduling tasks. The master node 502 determines where to run the one or more pods 508a, 508b, 508c, and 508d on the plurality of worker nodes 506a, 506b, and 506c based on various factors like resource availability, pod requirements, and any specified constraints. The master node 502 constantly monitors the cluster 500 for issues. If a worker node fails or a pod becomes unhealthy, the master node 502 can take corrective actions. This might involve restarting the pod on another worker node or taking other steps to maintain application uptime. The master node 502 facilitates communication between microservices within the cluster 500. It maintains a registry of services and enables service discovery, allowing microservices to find each other and interact seamlessly. Furthermore, the Kubernetes API 504 serves as the main point of access for interacting with the cluster 500. Users, tools, and other components can interact with Kubernetes through the Kubernetes API 504 to deploy applications, manage resources, and monitor cluster health.

FIG. 6A illustrates an implementation 625 of a fourth pod 508d hosted on a first worker node 506a, in accordance with an embodiment of the present disclosure. The first worker node 506a includes an operating system 637 that communicates with a Docker daemon 635. The fourth pod 508d includes a fourth container 627 with a service space 629, including a virtual agent 116d. Furthermore, the fourth container 627 includes libraries 631 and dependencies 633 to run the virtual agent 116d. The Docker daemon 635 acts as an intermediary, facilitating communication and resource access between containers and the host kernel of the operating system 637.

FIG. 6B illustrates an implementation 650 of a first pod 508a and third pod 508c hosted on a second worker node 506b, in accordance with an embodiment of the present disclosure. The second worker node 506b includes the operating system 637 that communicates with a Docker daemon 668. The first pod 508a includes a first container 652 with a service space 656 including a virtual agent 116a. Furthermore, the first container 652 includes libraries 658 and dependencies 660 to run the virtual agent 116a. The third pod 508c includes a third container 654 with a service space 662, including a virtual agent 116c. Furthermore, the third container 654 includes libraries 664 and dependencies 666 to run the virtual agent 116c. The Docker daemon 668 acts as an intermediary, facilitating communication and resource access between containers and the host kernel of the operating system 637.

FIG. 6C illustrates an implementation 637 of a second pod 508b hosted on a third worker node 506c, in accordance with an embodiment of the present disclosure. The third worker node 506c includes the operating system 637 that communicates with a Docker daemon 685. The second pod 508b includes a second container 667 with a service space 679, including a virtual agent 116b. Furthermore, the second container 667 includes libraries 681 and dependencies 683 to run the virtual agent 116b. The Docker daemon 685 acts as an intermediary, facilitating communication and resource access between containers and the host kernel of the operating system 637.

Access to the server system 106 may be provided to the developers and clients alike through a well-documented service API for developers to integrate the application into their products. Furthermore, Software Development Kits (SDKs) and code samples may be provided to simplify integration. Furthermore, a dedicated platform may be created for developers to access documentation, forums, and support resources. In several instances, developer contests and hackathons may be offered to foster engagement. The service API may be divided into modular API components, allowing each component to be developed, tested, and deployed independently. Furthermore, individual components can be scaled independently based on their workload. Examples of modular API components may include (1) authentication (for handling user authentication and authorization), (2) data validation (to validate incoming data to ensure the incoming data meets specific criteria), (3) error handling (to message error responses and provide informative messages), (4) database interactions (to interact with underlying databases to retrieve or store data), and (5) business logic (to implement core business rules and calculations).

Furthermore, the service API may be provided in most widely accepted protocols such as REST (Representational State Transfer), SOAP (Simple Object Access Protocol), GraphQL, RPC (Remote Procedure Call), WebSocket, gRPC, MessagePack, etc. In addition, the service API can be designed to support a variety of data formats to accommodate different use cases and developer preferences. Such data formats may include JSON (JavaScript Object Notation), XML (Extensible Markup Language), CSV (Comma-Separated Values), YAML (YAML Ain't Markup Language), etc. An API gateway is a critical component of modern application architectures. The API gateway acts as a single entrypoint for clients, providing security, load balancing, caching, monitoring, and more. The API gateway can be secured through several techniques including authentication and authorization (API Keys, OAuth 2.0, OpenID Connect, JSON Web Tokens (JWT)), encryption (Secure Socket Layer (SSL)/Transport Layer Security (TLS), data encryption), input validation, security headers (HTTP Strict Transport Security (HSTS), Content Security Policy (CSP), X-Frame-Options), API key management, logging and monitoring, web application firewall, Intrusion Detection System (IDS), security audits, security testing, and incident response plans.

Furthermore, the service API may be enabled with customizable API endpoints. Customizable API endpoints offer flexibility and adaptability to the application. Customizable API endpoints allow clients to tailor requests to their specific needs. Key components of customizable API endpoints include (1) endpoint structure (define a base endpoint URL, use path parameters to capture dynamic elements, and employ query parameters for optional filtering, sorting, and pagination), (2) parameter validation (ensure that incoming parameters adhere to expected data types and formats, and implement error handling for invalid inputs), (3) endpoint logic (develop the core logic to process requests and generate responses, and utilize parameter values to modify the API's behavior), (4) response formatting (choose a suitable data format (JSON, XML, etc.), and structure the response based on the requested parameters), and (5) security (protect the API using authentication and authorization mechanisms, and implement rate limiting to prevent abuse).

Furthermore, several measures may be taken to ensure cross-platform compatibility of the application implementing the aforementioned embodiments. These include (1) use of frameworks and libraries designed to be used with multiple platforms (frameworks such as Electron (for desktop apps), Xamarin, React Native, or Flutter (for mobile apps)), (2) adherence to platform guidelines and user experience standards to provide a native feel, (3) abstraction of platform specific code and use of conditional compilation or platform-specific modules to handle differences in functionality, (4) testing of the application (and microservices on all targeted platforms) and further automation of testing with cross-platform testing tools like Appium, BrowserStack, or Selenium, (5) implementing responsive design principles, flexible layouts, and scalable graphics to ensure the application adapts to different screen sizes and resolutions, (6) use of standardized data formats (for example, JSON, XML), consistent handling of data across platforms, and cloud-based or centralized storage solutions for data synchronization (7) minimizing the use of platform-specific features unless absolutely necessary, ensuring there are equivalent functionalities on other platforms and/or providing fallbacks, (8) ensuring web applications comply with modern web standards (HTML5, CSS3, JavaScript ES6) and testing web applications across different browsers and devices to ensure compatibility, (9) keeping thorough documentation of any platform-specific considerations and how they are handled, and (10) implementing Continuous Integration (CI) and Continuous Deployment (CD) pipelines to automate the building, testing, and deployment processes across different platforms.

The processor 110 executing the machine-readable instructions may deploy several mechanisms for automating backup and disaster recovery. The processor 110 may identify which data and applications are critical to the operational workflow and classify data based on its importance and recovery requirements. Furthermore, the processor 110 may deploy several third-party backup solutions based on the requirement. Popular options include AWS Backup, Azure Backup, Veeam, and Acronis. The processor 110 may further implement regular backups (daily, weekly, monthly) based on the criticality of the data. Several third-party tools and libraries may be used to automate the backup schedules to avoid manual intervention. Furthermore, in several embodiments, incremental or differential backups may be implemented to save time and storage space. These backups only capture changes since the last backup, reducing the amount of data to be stored. The machine-readable instructions may have built-in automated backup policies and retention rules. Furthermore, old backups may be deleted or archived according to the policies and retention rules to manage storage effectively. The processor 110 may further automate backup verification processes to ensure backups are not corrupted and can be restored successfully. Tools like BackupChecker and Bacula may be deployed.

For the automation of disaster recovery, a comprehensive Disaster Recovery Plan (DRP) may be developed that outlines the steps to take during a disaster. The DRP may include roles, responsibilities, and communication plans. A DR solution that meets RTO (Recovery Time Objective) and RPO (Recovery Point Objective) requirements may be selected. Options include AWS Disaster Recovery, Azure Site Recovery, and Zerto. The processor 110 may automate data replication to a secondary site or cloud environment. In that regard, the processor 110 may use tools that support real-time replication and automated failover, such as AWS CloudEndure, Azure Site Recovery, and Veeam. Furthermore, regular DR drills may be scheduled and automated to test the effectiveness of the DR plan, while ensuring that failover and failback processes work as expected. Furthermore, the processor 110 may implement monitoring tools that provide real-time alerts for backup failures and other critical events. Tools like Nagios, Zabbix, and Prometheus can help monitor the health of the backup and DR systems. Version control and configuration management tools like Git, Ansible, or Puppet may be used to automate the deployment and configuration of applications during disaster recovery.

In addition, backups may be stored in multiple locations, including geographically separated data centers, to protect against regional disasters. Furthermore, backups may be encrypted both in transit and at rest to protect sensitive data. The processor 110 may use tools that comply with security standards and regulations. Automated data integrity checks may be implemented to ensure that backups are consistent and complete. Furthermore, detailed documentation of the backup and DR processes may be maintained, including scripts, policies, and recovery procedures.

A person skilled in the art would appreciate that although several embodiments discussed in the aforementioned discussion have been implemented in an organizational setup, the embodiments as disclosed below may extend to other equivalent and non-equivalent scenarios as well, such as college campuses or cities. The embodiments allow users to run “what if” scenarios to evaluate life decisions, such as selecting the right college or career path, providing valuable insights for personal and professional development. Therefore, the several embodiments discussed above could be open to the public for personal uses (to create their environment, create their digital twin, and run “what if” scenarios to make life decisions).

The disclosed method 300, or one or more operations of these methods may be implemented using software including computer-executable instructions stored on one or more computer-readable media (for example, non-transitory computer-readable media, such as one or more optical media discs, volatile memory components (for example, DRAM or SRAM)), or nonvolatile memory or storage components (for example, hard drives or solid-state nonvolatile memory components, such as Flash memory components) and executed on a computer (for example, any suitable computer, such as a laptop computer, netbook, Web book, tablet computing device, smartphone, or other mobile computing devices). Such software may be executed, for example, on a single local computer or in a network environment (for example, via the Internet, a wide-area network, a local-area network, a remote web-based server, a client-server network (such as a cloud computing network), or other such networks) using one or more network computers.

Additionally, any of the intermediate or final data created and used during the implementation of the disclosed methods or systems may also be stored on one or more computer-readable media (for example, non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Particularly, the server system 106 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media.

Examples of non-transitory computer-readable storage media include magnetic storage media (such as floppy disks, magnetic tapes, hard disk drives, etc.), optical magnetic storage media (for example, magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (for example, electric wires and optical fibers) or a wireless communication line.

Various embodiments of the disclosure, as discussed above, may be practiced with steps and/or operations in a different order, and/or with hardware elements in configurations that are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
generating, by a controller, a plurality of virtual agents with Artificial Intelligence (AI) capabilities based at least on organizational data associated with an organization, the organizational data received from one or more of a Human Resources Information System (HRIS) server, an enterprise server, or a communications server, wherein the plurality of virtual agents is provided with access to the organizational data;
delegating, by the controller, at least a portion of operational workflows associated with the organization to one or more of the plurality of virtual agents;
generating, by the controller, a plurality of employee digital twins associated with a plurality of respective employees of the organization, based at least on employee-specific data;
generating, by the controller, at least one workplace digital twin representing at least one respective workplace environment in the organization; and
enabling, by the controller, communication amongst a plurality of disparate groupings for enabling execution of the operational workflows,
wherein the plurality of disparate groupings is generated by selecting a plurality of entities from one or more of a plurality of employee devices associated with the plurality of respective employees, the plurality of virtual agents, the plurality of employee digital twins, or the at least one workplace digital twin.

2. The computer-implemented method as claimed in claim 1, further comprising periodically updating, by the controller, one or more of the plurality of virtual agents, the at least one workplace digital twin, and the plurality of employee digital twins, in response to one of new data generation events and based on differences between expected operational outcomes and actual observed operational outcomes.

3. The computer-implemented method as claimed in claim 1, wherein the plurality of virtual agents comprises one or more of a virtual Subject Matter Expert (SME), a virtual coach, a virtual project planner, or a virtual personal assistant.

4. The computer-implemented method as claimed in claim 3, wherein the virtual SME implements a scraper agent to gather data from a plurality of web-based or local database repositories to generate one or more of a structured, a semi-structured, or an unstructured expert-data repository related to a given subject matter.

5. The computer-implemented method as claimed in claim 1, wherein one or more of the plurality of virtual agents are configured with human-like personality traits in accordance with one or more personality assessment frameworks.

6. The computer-implemented method as claimed in claim 1, further comprising integrating, by the controller, a virtual agent, of the plurality of virtual agents, with a workflow automation application for automating an operational workflow delegated to the virtual agent.

7. The computer-implemented method as claimed in claim 1, further comprising generating, by the controller, a plurality of employee personality profiles associated with the plurality of respective employees based at least on the employee-specific data and one or more personality assessment frameworks.

8. The computer-implemented method as claimed in claim 7, further comprising:
generating, by the controller, a plurality of employee anti-personality profiles corresponding to the plurality of respective employee personality profiles, by reversing values of parameters in the one or more personality assessment frameworks; and
generating, by the controller, a plurality of anti-employee digital twins from the plurality of employee anti-personality profiles,
wherein one or more of the plurality of entities for generating the plurality of disparate groupings are selected from the plurality of anti-employee digital twins.

9. The computer-implemented method as claimed in claim 8, wherein:
the plurality of employee digital twins is generated, by the controller, based on Multi-Objective Optimization (MOO) of competing priorities of the organization and the plurality of employees; and
the operational workflows are modified, by the controller, through the MOO, to mitigate negative impacts of traits represented by the plurality of anti-employee digital twins.

10. The computer-implemented method as claimed in claim 8, wherein the plurality of employee digital twins and the plurality of anti-employee digital twins are utilized, by the controller, to simulate a plurality of decision scenarios within the organization.

11. The computer-implemented method as claimed in claim 10, wherein the plurality of decision scenarios comprises layoff and productivity strategies, team optimization, manager-employee matching, organizational restructuring, business unit analysis, succession planning, and project-based team structuring.

12. The computer-implemented method as claimed in claim 11, wherein the team optimization is performed in one or more of an exploratory mode enabling manual addition of a plurality of team members of a team in entirety, an advisory mode comprising receiving AI recommendations for building at least a part of the team based on a plurality of predetermined organizational goals, or an optimization mode comprising automatic discovery of the plurality of team members based on the plurality of predetermined organizational goals, the plurality of team members selected from a group consisting of the plurality of employee digital twins and the plurality of anti-employee digital twins.

13. The computer-implemented method as claimed in claim 7, wherein communication between an employee using a respective employee device and an entity selected from a group consisting of the plurality of virtual agents, the plurality of employee digital twins, and the at least one workplace digital twin, is customized, by a virtual agent, based on an employee personality profile associated with the employee.

14. The computer-implemented method as claimed in claim 7, wherein a virtual agent provides personalized suggested responses to two employees during a communication between the two employees through two respective employee devices, and wherein the personalized suggested responses are provided to a message sender employee based on an employee personality profile of a message receiver employee.

15. The computer-implemented method as claimed in claim 1, wherein generating, by the controller, the at least one workplace digital twin further comprises:
accessing, by the controller, one or more goals intended to be achieved through the at least one workplace digital twin;
performing, by the controller, data collection from a plurality of data sources, the plurality of data sources comprising one or more of the HRIS server, the enterprise server, or the communications server;
building, by the controller, the at least one workplace digital twin using the collected data and one or more of a simulation software, a low-code platform, a spreadsheet, or a database; and
integrating, by the controller, the at least one workplace digital twin with Information Technology (IT) infrastructure associated with the organization.

16. The computer-implemented method as claimed in claim 1, wherein one or more entities among the plurality of virtual agents, the at least one workplace digital twin, or the plurality of employee digital twins are implemented as containerized microservices and orchestrated using a container orchestration platform.

17. A server system, comprising:
a controller, comprising:
a processor, and
a memory unit operably connected to the processor, the memory unit comprising machine-readable instructions, the machine-readable instructions, when executed by the processor, cause the controller to:
generate a plurality of virtual agents with Artificial Intelligence (AI) capabilities based at least on organizational data associated with an organization, the organizational data received from one or more of a Human Resources Information System (HRIS) server, an enterprise server, or a communications server, wherein the plurality of virtual agents has access to the organizational data,
delegate at least a portion of operational workflows pertaining to the organization to one or more of the plurality of virtual agents,
generate a plurality of employee digital twins associated with a plurality of respective employees of the organization, based at least on employee-specific data, generate at least one workplace digital twin representing at least one respective workplace environment in the organization, and
enable communication amongst a plurality of disparate groupings for enabling execution of the operational workflows,
wherein the plurality of disparate groupings is generated by selecting a plurality of entities from one or more of a plurality of employee devices associated with the plurality of respective employees, the plurality of virtual agents, the plurality of employee digital twins, or the at least one workplace digital twin.

18. The server system as claimed in claim 17, wherein the controller is further caused to update one or more of the plurality of virtual agents, the at least one workplace digital twin, and the plurality of employee digital twins periodically, in response to new data generation events, or based on differences between expected operational outcomes and actual observed operational outcomes.

19. The server system as claimed in claim 17, wherein the plurality of virtual agents comprises one or more of a virtual Subject Matter Expert (SME), a virtual coach, a virtual project planner, or a virtual personal assistant.

20. The server system as claimed in claim 19, wherein the virtual SME is configured to implement a scraper agent to gather data from a plurality of web-based or local database repositories to generate one or more of a structured, a semi-structured, or an unstructured expert-data repository related to a given subject matter.

21. The server system as claimed in claim 17, wherein one or more of the plurality of virtual agents are configured with human-like personality traits in accordance with one or more personality assessment frameworks.

22. The server system as claimed in claim 17, wherein the controller is further caused to integrate a virtual agent, of the plurality of virtual agents, with a workflow automation application for automating an operational workflow delegated to the virtual agent.

23. The server system as claimed in claim 17, wherein for generating the plurality of employee digital twins, the controller is further caused to generate a plurality of employee personality profiles associated with the plurality of respective employees based at least on the employee-specific data and one or more personality assessment frameworks.

24. The server system as claimed in claim 23, wherein the controller is further caused to:
generate a plurality of employee anti-personality profiles corresponding to the plurality of respective employee personality profiles, by reversing values of parameters in the one or more personality assessment frameworks; and
generate a plurality of anti-employee digital twins from the plurality of employee anti-personality profiles,
wherein one or more of the plurality of entities for generating the plurality of disparate groupings are selected from the plurality of anti-employee digital twins.

25. The server system as claimed in claim 24, wherein the controller is further caused to:
generate the plurality of employee digital twins based on Multi-Objective Optimization (MOO) of competing priorities of the organization and the plurality of employees; and
modify the operational workflows, through the MOO, to mitigate negative impacts of traits represented by the plurality of anti-employee digital twins.

26. The server system as claimed in claim 24, wherein the controller is further caused to utilize the plurality of employee digital twins and the plurality of anti-employee digital twins to simulate a plurality of decision scenarios within the organization.

27. The server system claimed in claim 26, wherein the plurality of decision scenarios comprises layoff and productivity strategies, team optimization, manager-employee matching, organizational restructuring, business unit analysis, succession planning, and project-based team structuring.

28. The server system as claimed in claim 27, wherein the controller is further caused to perform the team optimization in one or more of an exploratory mode enabling manual addition of a plurality of team members of a team in entirety, an advisory mode comprising receiving AI recommendations for building at least a part of the team based on a plurality of predetermined organizational goals, or an optimization mode comprising automatic discovery of the plurality of team members based on the plurality of predetermined organizational goals, the plurality of team members selected from a group consisting of the plurality of employee digital twins and the plurality of anti-employee digital twins.

29. The server system as claimed in claim 23, wherein communication between an employee using a respective employee device and an entity selected from a group consisting of the plurality of virtual agents, the plurality of employee digital twins, and the at least one workplace digital twin, is configured to be customized, by a virtual agent, based on an employee personality profile associated with the employee.

30. The server system as claimed in claim 23, wherein a virtual agent is configured to provide personalized suggested responses to two employees during a communication between the two employees through two respective employee devices, wherein the personalized suggested responses are provided to a message sender employee based on an employee personality profile of a message receiver employee.

31. The server system as claimed in claim 17, wherein for generating the at least one workplace digital twin further, the controller is further caused to:
access one or more goals intended to be achieved through the at least one workplace digital twin;
perform data collection from a plurality of data sources, the plurality of data sources comprising one or more of the HRIS server, the enterprise server, or the communications server;
build the at least one workplace digital twin using the collected data and one or more of a simulation software, a low-code platform, a spreadsheet, or a database; and
integrate the at least one workplace digital twin with Information Technology (IT) infrastructure associated with the organization.

32. The server system as claimed in claim 17, wherein the controller is further caused to implement one or more entities out of the plurality of virtual agents, the at least one workplace digital twin, or the plurality of employee digital twins as containerized microservices orchestrated using a container orchestration platform.
